(19) United States
(12) Patent Application Publication
(10) Pub. No.: US 2025/0387727 A1
(43) Pub. Date: Dec. 25, 2025

(54) THE HANSON REDWOOD XYLEM WATER PRODUCTION SYSTEM

(71) Applicant: Matthew Vernon Hanson, Sun Prairie, WI (US)

(72) Inventor: Matthew Vernon Hanson, Sun Prairie, WI (US)

(21) Appl. No.: 19/255,877

(22) Filed: Jun. 30, 2025

Related U.S. Application Data
(63) Continuation-in-part of application No. 18/232,667, filed on Aug. 10, 2023.

(51) Int. Cl. B01D 5/00; C25B 1/04

(52) U.S. Cl. CPC B01D 5/0012; B01D 5/0057; C25B 1/04

(57) ABSTRACT

The water production system described herein uses subsurface temperatures to cool water to 55 degrees Fahrenheit. That geothermally cooled water is then sent down the interior of a copper column. Thermal transfer then causes the surface of the copper column to cool. In warm humid environments, condensation will form on the outside of the copper column, much like water condenses on a glass of ice water. Alternative formats include adding a pressure sleeve to the copper column, changing the column into a sphere, and for the pressure-sleeved version dropping the entire thing down a hole wherein the outer surface of the pressure sleeve comes into contact with subsurface ground temperatures cooling the pressure sleeve and creating additional cooling surface area. Alternative formats also include placing the invention inside of telephone or light poles and using artificial xylem and evapotranspiration to draw geothermally cooled water up the column.

This is a continuation-in-part of U.S. patent application Ser. No. 18/232,667.

### BACKGROUND OF THE INVENTION

To begin, the reader should imagine 50,000 copper pipes standing at the top of a hill, 6 inches (12.7 cm) in diameter, tall as a Redwood tree (100 meters), 12 mm thick (for stability), and with 10-micron electroless nickel plating (for corrosion resistance).

Now imagine each of those copper pipes lit with the dawn sun and glistening with condensation.

In other words, a kind of “condensation forest” wherein water is pumped from underground (where sub-surface temperatures are always 55 degrees Fahrenheit) to the top of each pipe.

That water then runs down the interior of each pipe in a solid column, and wherein the “cooling” of the water is handled passively by subsurface temperatures in a geothermal loop at the bottom of the system.

The current invention also uses sub-surface temperatures for the purpose of “farming the air” for water production.

However, in this (new) application, water is cooled in a geothermal loop underground, and the condensation happens above ground on the surface of a pipe.

In Ser. No. 18/232,667 compressed humid air is pumped below ground, sub-surface temperatures act as the cooling medium on the outside of the pipe—and water then condenses on the interior of the pipe.

Here everything is reversed, and subsurface temperatures cool the interior of the pipe instead (via geothermally cooled water).

Essentially, this is a reversal of the original system. Here water condenses outside, as opposed to inside, the pipe.

In its most basic form, the current invention pumps water underground into a geothermal loop. Sub-surface temperatures cool that water. That water is then pumped to the top of a copper column. That copper column is then “filled to the brim” with a solid column of cold water. That cold water cools the column via thermal transfer. The cold water descends the interior of the column back to the geothermal loop, completing the water-cooling cycle.

That column is then exposed directly to humid air. The difference in temperature causes condensation to form on the surface of the column, just like condensation forms on a glass of ice water on a picnic table on a hot, humid, summer day. And that water is collected at the bottom of the column.

Except here the “glass of ice water” is 100 meters tall, 6 inches in diameter, and copper is substituted for the glass.

The water inside the “copper glass” of the column isn't ice water, however. It is simply a column of cold (55-degree Fahrenheit) water that is cooled by subsurface temperatures in a continual loop.

The additional improvements here are essentially a new invention, but the underlying idea—using subsurface temperatures for water production—remains largely the same.

### BACKGROUND OF THE INVENTION

Several years ago, the inventor of this invention, and of application Ser. No. 18/232,667, became interested in industrial scale water production.

An old air conditioner conked out, the inventor went to get a replacement at Best Buy and loaded the replacement air conditioner into an Uber.

But it was raining cats and dogs that day.

So by the time the inventor got the air conditioner into the Uber, the box was soaked.

And by the time the inventor got the box from the Uber to the front door of his apartment building—the box was waterlogged. It really was raining that hard.

So the inventor unpacked the air conditioner, took the wet box down to the trash bins, and then attempted to put the air conditioner in the window . . . and found that it didn't fit.

As the waterlogged box had already been trashed, the inventor couldn't return the air conditioner. So the inventor was stuck with a brand-new air conditioner that he couldn't use.

However, the new air conditioner did fit in the windows of a “false porch”—and with a bit of ingenuity, a box fan, and a broom handle (to hold the box fan in place), the inventor was able to fit the air conditioner into the interior window, vent the hot air from the air conditioner to the outdoors with the box fan, and enjoy cool air from the new air conditioner . . . for about ten minutes.

Until the water started dripping from the air conditioner onto the ledge below the interior windowsill.

Being somewhat creative, the inventor took an old gallon milk jug, cut it in half, and used the bottom portion to capture the water from the air conditioner. See FIG. 12.

Thereafter was “the summer from hell” as during hot humid nights, the inventor basically had to get up every hour, on the hour, to empty the half gallon jug into the sink—or there would have been flooding on the porch.

The inventor observed, quite dryly: “that is a heck of a lot of water.”

Most of the time water just drips innocuously from billions of air conditioners worldwide—and is lost forever.

Nor is that lost water ever really thought about. By anyone.

But over that summer the inventor was forced to empty that half gallon jug again, and again, and again.

And that experience drove home the idea that in humid conditions, even small air conditioners can produce an incredible amount of water. In very humid conditions, and with an air conditioner running full blast, about half a gallon per hour, more or less.

At that point, as the saying goes, “I was standing at home plate. And then it hit me.” And the entire concept for Ser. No. 18/232,667 sprang into being while the inventor was standing there one day about to carry (yet another) half gallon of water from the air conditioner to the sink.

The entirety of patent application Ser. No. 18/232,667 was then written and filed in an afternoon.

A year or so later, the inventor found himself visiting his sister, and hugging a Redwood tree in Arcata, California. And the inventor became interested in the physics of the Redwood forests, their high humidity, and in particular the structure of Redwood trees, and how they a) pump water up a 100-meter column using an entirely passive system, and b) absorb water from the air. The current invention is a tribute to those beautiful trees. They have been doing what this invention suggests, at least in part anyway—for 240 million years.

### Farming the Atmosphere for Water

Water production at a feasible industrial scale is, at the moment, largely done by desalination. Extracting salt from seawater to produce fresh water is a technological challenge however, as it is both equipment-heavy, and requires enormous amounts of electricity.

However, the atmosphere, particularly in coastal marine environments, provides an abundance of humid air which can (theoretically) be farmed for fresh water.

Application Ser. No. 18/232,667 was issued a patent on [date]. In the process of arguing that application, the inventor considered what other possibilities existed for large scale water production using similar or analogous types of techniques, and simple and easy-to-understand technology.

The process of inventing is largely associative—and in this current application, you have a trip to a Redwood forest, an existing invention, and the analogy of the Redwood tree combining into something entirely new. And quite ironically, there is also a pine tree (though not a Redwood) on the porch in FIG. 12—where this entire journey began.

### BRIEF DESCRIPTION OF THE DRAWINGS

FIG. 1 is a drawing of a 100-meter-tall column (the size of a Redwood tree) with a human being (2 meters) and a tree for scale.

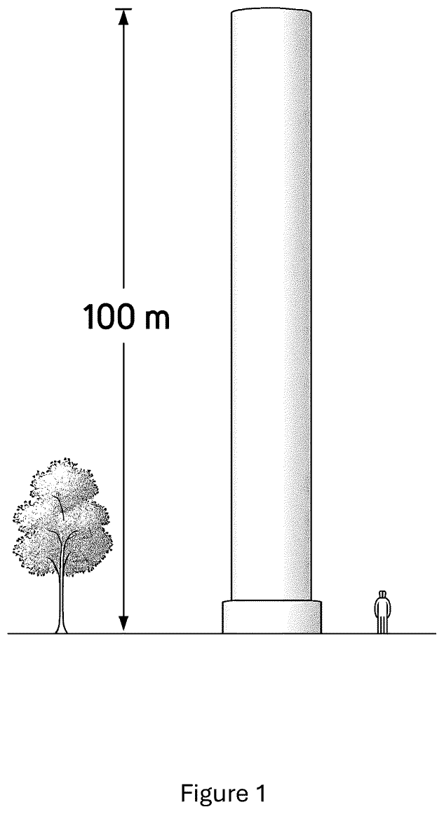

FIG. 2 is a “forest” of 100-meter columns near the ocean.

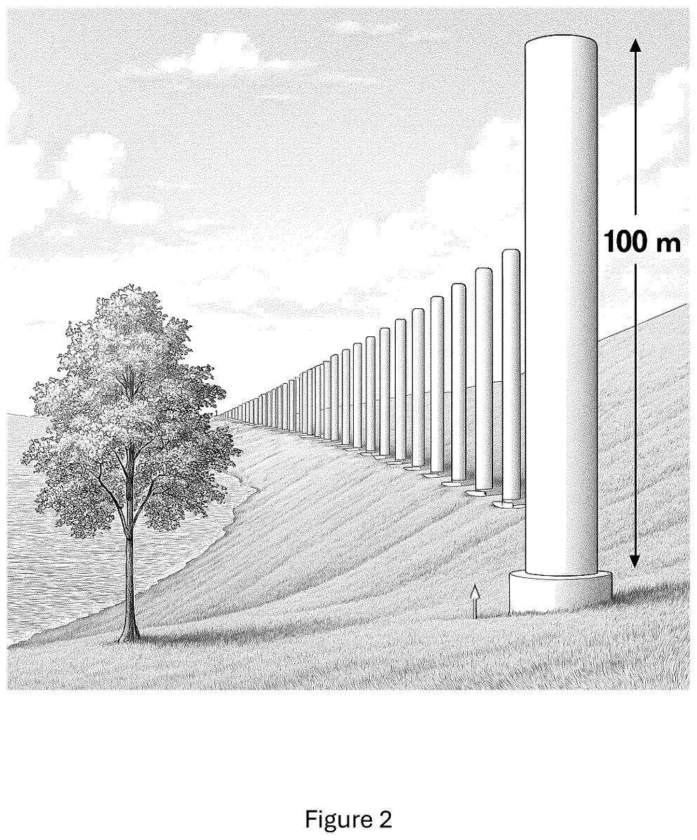

FIG. 3 is a “water production forest” conceptual drawing of the invention.

FIG. 4 is the internal structure of the column, with 41 being the upper water reservoir, 42 being a pipe leading to the upper reservoir from the base, 43 being the external surface of the column, and 44 being an internal funnel increasing the speed of the water via the Bernoulli principle (smaller diameters=greater speed) as the water descends the interior of the column.

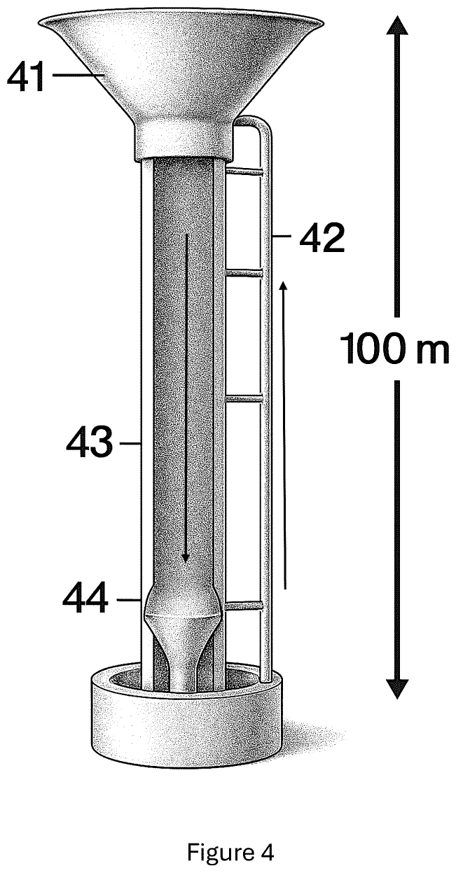

FIG. 5 is a configuration wherein a copper pipe at 51 curls around the outside of the copper column (ideally wrapped directly on the surface of the column) and catch aprons at 52 channel water condensing on the surface of the column at 53 into the small copper pipe at 51, where water accelerates down the tube and enters the column base at 54.

FIG. 6 is the column base where the water capture line at 61 is wound around the main column at 62. A funnel shape accelerates water inside the column to a narrower gauge tube at 63 (benefitting from increased speeds due to the Bernoulli principle). High-speed water travels down that narrow-gauge tube, which enters a Tesla (or other) turbine at 64, which generates electricity. Water from the Tesla turbine at 64 then exits the column base at 65 to return to a geothermal loop (not shown). At 66, water from the condensation collection tube descends to a second Tesla turbine at 67, which generates electricity. Water then water exits the 67 Tesla turbine through a pipe at 68 to collect in water storage at 69 where that water can be ported to a plurality of uses.

FIG. 7 is an iteration of FIG. 6 with the addition of pressure walls at 71, leading to a higher-pressure chamber surrounding the column at 72, and that higher pressure air is combined at 73 with water from condensation at 66 to create a mix of water and high-pressure air which travels through the Tesla turbine at 67. The Tesla turbine then generates electricity. Excess air pressure and condensed water is then sent from the 67 Tesla turbine through a pipe at 68 and then released into the water chamber at 69. Water from 69 can then be sent to reclamation/filtration, bottling, or a plurality of other uses. Excess air pressure from the system can be released into an additional Tesla turbine at 74, further adding energy to the system.

FIG. 8 is an external view of the “pressure hull” version of the system, with a water reservoir at 81, fed by a pipe at 82 from the geothermal pump at 83, which draws cold water from the underground loop in the geothermal system at 84, and where an air compressor at 85 feeds a pipe at 86 entering the pressure hull at 87 to create a high pressure high humidity environment inside the pressure hull surrounding a copper column allowing for the condensation of water.

FIG. 9 is an example of a hexagonal “honeycomb” xylem construction in the interior of a copper column.

FIG. 10 is an iteration of FIG. 9 except the white dots depicts “pits” (narrow points where water transfer occurs between xylem cells) at the end of each segment of the artificial xylem. Also see FIG. 18.

FIG. 11 is a “spherical” version of the invention, where in at 101 a water line carrying cool water from a geothermal loop enters the sphere at 102. Water exits the sphere to return to the geothermal loop for cooling at 103. Water from the 103 pipe enters a Tesla (or other) turbine at 104 which generates electricity from water pressure. Water exits the 104 Tesla turbine to a pipe at 105 and is sent underground to a geothermal loop at 106 where water is geothermally cooled. A pump at 107 sends the geothermally cooled water back up a pipe at 108 to the top of the sphere. Geothermally cooled water from the 108 pipe re-enters the sphere at 101 completing the cooling cycle. On the left side of the invention, at 109 an industrial air compressor sends compressed humid air through a pipe at 110, leading to a high humidity, high pressure chamber at 111. Water from the humid air condenses on the outer surface of the water-cooled sphere and falls to the bottom of the 111 pressure chamber. At 112, high pressure (drier) air leaves the pressure chamber. Water which has condensed on the cool surface of the 102 sphere and dripped to the bottom of the 111 pressure chamber is collected at the bottom of the pressure chamber at 113 and is ported to a pipe at 114 which combines with the high pressure air pipe at 112 to create a mix of both condensed water and high-pressure air. At 115 that high pressure water/air mix is sent through a Tesla turbine to generate electricity. Water and air pressure exits the Tesla turbine and travels through a pipe at 116 to a reservoir at 117. Water will fall to the bottom of the 117 reservoir. Air will rise and/or fill the empty space at the top of the 117 reservoir. Any excess air pressure in the 117 reservoir can then be sent through a pipe at 118 to an additional Tesla turbine at 119 which can generate electricity. Water from the 117 reservoir can be sent to bottling, filtration, reclamation, or a plurality of uses. In an additional configuration, pipes 112 and 114 do not connect, and high pressure (drier) air at 112 is sent directly via a pipe (the dashed line) at 120 to the Tesla turbine at 119 to generate electricity. In that configuration the high-pressure (drier) air does not run through the loop connected to the 117 reservoir.

FIG. 12 is a picture of the air conditioner (and pine tree) that started it all.

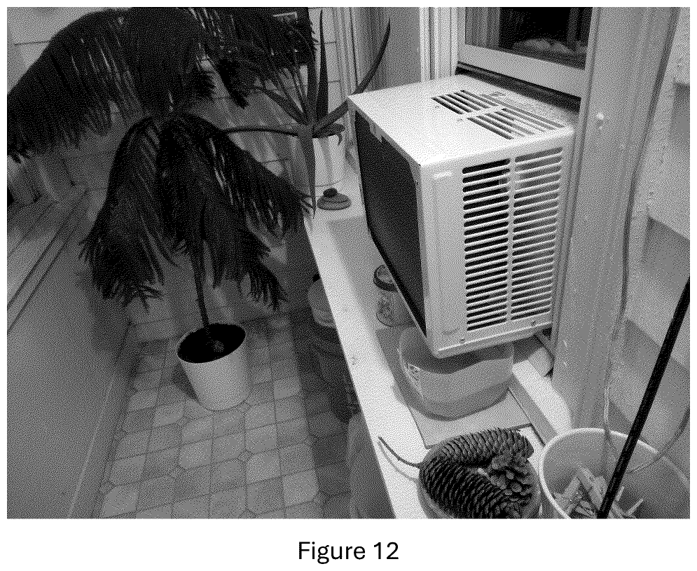

FIG. 13 is the “solar leaf” configuration where panels containing “artificial leaves” (per Nocera) are seen at 131 mimicking evapotranspiration and are supported by artificial “branches” seen at 132, and where a small Tesla turbine at 133 pumps water from the top of the column at 134 into the branches and panels at 131 and 132. For each “solar leaf panel” you have a nozzle at 135 that produces hydrogen gas and a nozzle at 136 which produces oxygen gas. At 137 you have an artificial leaf immersed in water at 138. The 138 water surrounds the 137 artificial leaf which in the presence of sunlight will trigger electrolysis producing said hydrogen gas at 135 and said oxygen gas at 136. Water is fed into the artificial leaf through nozzles at 139 connected to the artificial branches at 132 and Tesla turbine at 133.

FIG. 14 is a diagram of the structure of tracheids and vessels inside of trees. Source: https://blogionik.org/blog/2017/03/16/tracheids-vessels/

FIG. 15 is a diagram of water responsive fabrics. Source: https://link.springer.com/article/10.1007/s42765-023-00269-5

FIG. 16 is a “tilted mountainside” version of the invention which has a copper column at 1610, the internal water level at 1611 (i.e. the pipe is always completely filled with water), a feeder pipe at 1612 which keeps the copper column filled with geothermally cooled water which is fed by a “boost” pump at 1613. The boost pump pulls water from the geothermal pipe buried at least 4 feet underground at 1614. The pipe at 1614 is cooled by subsurface temperatures. At 1615 a pump sends water up-slope through the geothermally cooled pipe at 1614. The pipe at 1614 can also be a more coiled or complex geothermal loop. At 1616 a Tesla (or Pelton) turbine captures energy from the water pressure inside the copper column which is sent through a narrower gauge piping at 1617 to benefit from the Bernoulli Principle and increased water speeds. That water from the 1616 Tesla turbine is then sent back underground to the geothermal system through a pipe at 1624 to the pump at 1615 to restart the cooling cycle. Directly underneath the large water-filled copper column, at 1618 we find a “water catch channel” (which can be flared or aproned to the size of the copper column) which runs along the ground at 1623 (the dashed line) and catches moisture which condenses on the surface of the 1610 copper column. As that water from condensation descends down the 1618 catch channel, it accelerates due to gravity. At 1619 the gauge of the catch channel pipe is narrowed to benefit from increased speeds due to the Bernoulli Principle, and that water at higher pressure is run through a Tesla turbine at 1620 to generate electricity. That water travels through a pipe at 1621 from the 1620 Tesla turbine to a reservoir at 1622 for reclamation, bottling/filtration, or a plurality of other uses.

FIG. 17 is a high-pressure version of FIG. 16, wherein the dashed line at 171 is ground level, 172 is a water-filled copper column, and 173 is a high pressure, high humidity pressure sleeve surrounding the copper column. At 174 we find the water level of geothermally cooled water inside the column (i.e. always filled). At 176 an industrial air compressor feeds the high-pressure high-humidity sleeve through a pipe at 175. A pipe at 177 feeds geothermally cooled water into the interior of the copper column from a “boost” pump at 178. A geothermal loop filled with water at 179 is at least 4 feet below the surface benefits from geothermal cooling. This geothermally cooled pipe at 179 could also be a more extensive geothermal loop with more coils or bends. At 180 a pump pushes water through the geothermal loop upslope against gravity towards the top of the system. At 181, a Tesla (or Pelton) turbine takes water pressure descending the inside of the copper column and transforms that water pressure into electricity, which benefits from the gravity pressure as well as the narrower pipe at 182 which speeds up the water and benefits from the Bernoulli Principle (narrower gauge=higher speeds). That water is then sent back underground via a pipe at 188 to the pump at 180, completing the water-cooling cycle. At 187 a pipe carries a mix of condensed water and compressed air from the pressure tube at 173 to an additional Telsa turbine at 183. That mix of water and compressed air turns the Tesla turbine at 183 to generate electricity. Water and air pressure then travel from that 183 Tesla turbine into a pipe at 184 (which might be refrigerated to further separate water from air). Water is then collected for reclamation, bottling, or a plurality of other uses in a reservoir at 185, and where an additional turbine at 186 uses spare air pressure left over from the system to generate further electricity which can either be used by the system or ported to the grid.

It should be noted that in FIGS. 6, 7, 11, 16, and 17 that the Tesla turbines (energy capture) will likely be connected via wire to the pumps and compressors (energy expenditure) parts of the system or to appropriate transformers and/or battery storage. The electrical wires and probable connections between those components were omitted in the drawings to keep the drawings from becoming cluttered. But as a general rule of thumb, energy generators (turbines) will partially or fully power energy expenders (pumps or compressors) throughout the system.

FIG. 18 is a diagram of xylem, trachieds, and perforation plates.

FIG. 19 is a “Telephone Pole” version of the invention where at 1911 you have a copper (or other metal) telephone pole. At 1912 you have a catch apron (which can also be placed at intervals up the pole—as in FIG. 5, Item 52). You could also wind a curving copper pipe on the outside of the pole channeling condensed water as in FIG. 5, FIG. 6, and FIG. 7. At 1913 you have a pipe leading from the catch basin to a Tesla turbine at 1914. The Tesla turbine captures a small amount of electricity from the condensation accelerating down the outside of the pole. At 1915 a pipe leads from the Tesla turbine to a storm drain at 1916 where water is sent into the sewer system for reclamation. At 1917 we have a narrowing of the internal column of water inside the 1911 telephone copper pole, leading to a narrow-gauge pipe at 1918 which benefits from increased water speeds due to the Bernoulli principle. At 1919 a Tesla (or other) turbine generates electricity from the high-speed jet of water exiting the 1918 pipe. At 1920, water from the 1919 Tesla turbine enters a geothermal ground loop where water is cooled to 55 degrees Fahrenheit. At 1921, water is sent from the geothermal loop to a pump at 1922 which pushes geothermally cooled water to the top of the telephone pole through a pipe at 1923 where that cooled water enters the (hollow) telephone pole at 1924 to complete the water cooling cycle.

FIG. 20 utilizes the same numerical elements as FIG. 19, but is shown in FIG. 20 using a light pole instead.

FIG. 21 is a top view of the “Underground System” wherein 2110 is the copper column filled with geothermally cooled water, 2111 is the high-pressure chamber, 2112 is the outer surface of the pressure chamber, which is clad in copper, and 2113 is the ground surrounding the outer surface of the pressure chamber. The 2113 ground cools the 2112 outer copper pressure chamber wall geothermally, leading to a 55-degree Fahrenheit surface temperature on the outer wall of the 2111 pressure chamber.

FIG. 22 is a side view of the “Underground System” wherein 2210 is the ground surrounding the system. 2211 is the outer copper wall of the pressure chamber. 2212 is the interior of the pressure chamber which surrounds the internal water-filled column at 2213. The 2213 water-filled column is cooled internally by geothermally cooled water. At 2214 we see a funnel narrowing the bottom of the column to a narrower gauge pipe at 2215, which leads to a Tesla turbine at 2216 which captures some of the energy of the weight of the water inside the 2213 column. Even though the 2213 column is underground, it is still free standing inside the 2212 pressure chamber and therefore that water inside the 2213 column has weight. Water from the Tesla (or Pelton) turbine at 2216 leads to a pipe at 2228 which leads to a geothermal cooling loop at 2229 and exits the geothermal cooling loop at 2230 to a pump at 2217 which sends water upwards through a pipe at 2218 which enters the interior of the 2213 copper column via a pipe at 2219, completing the water cooling cycle for the 2213 copper column. At the very top of the invention at 2220 we find an industrial air compressor which sends compressed humid air into the 2212 pressure chamber between the 2213 copper column and the 2211 copper-clad wall of the pressure chamber. Towards the bottom left of the invention, we find Item 2221 which is a second Tesla turbine which generates electricity from three sources. First, from condensed water falling downwards along the surface of the 2213 geothermally water-cooled column at 2213. Second, from condensed water falling downwards along the internal surface of the copper pressure wall at 2211. And third, energy can also be generated from the excess air pressure from the system in the 2212 pressure chamber. That mix of air and water pressure travels through a pipe at 2231 to the Tesla turbine at 2221 to generate electricity. It should be noted that both the surface of the 2213 copper condensing column and the 2211 inner wall of the pressure chamber could have copper tubing wound around them as per Item 51 in FIG. 5 and Item 61 in both FIG. 6 and FIG. 7. The surface of the copper condensing column and the internal wall of the pressure chamber could also have catch aprons similar to Item 52 in FIG. 5 in order to more easily port condensing water into that copper tubing and capture additional water pressure: water in that (thinner) copper tubing would have a pressure of its own. In summary, water and air pressure exit the pressure chamber at 2231 to enter the Tesla turbine at 2221 to generate electricity. Air pressure and water is then ported through a pipe at 2222 into a reservoir at 2223. An additional Tesla turbine can be added to the top of the reservoir at 2228 to generate electricity from any remaining air pressure. A pump at 2224 takes water from the reservoir at 2223 and pumps it upwards through a pipe at 2225 into a second reservoir at 2226. Water in the 2226 reservoir can be sent to bottling, filtration, or a plurality of other uses. At the top of the invention at 2227 we find a dashed line representing the ground surface. Additionally, to the right in the drawing we find the major elements of the Underground System. The ground surrounding the system (2210) the outer copper plated pressure wall (2211), the space between the outer pressure wall and the column at 2212 filled with compressed humid air, and the column itself at 2213 filled with geothermally cooled water. This is what it would look like (minus all of the design elements to the left which would be added in different orientations) if you installed the invention underground along a mountainside or hillside at an angle.

FIG. 23 is a conceptual drawing of a Redwood tree at the bottom of 100-meter borehole.

FIG. 24 is a conceptual drawing of three Redwood trees stacked end-to-end in a 300-meter borehole.

FIG. 25 is an iteration of the “Underground System” except the borehole is sent to a greater depth, and each geothermally cooled water column has its own cell and compressed humid air is sent to each of the pressure chambers in those cells separately from the surface, and wherein all other parts of the Underground System (from FIG. 22) remain largely the same in each of those compartments but are not shown here.

FIG. 26 is an “underground forest” of the Underground System “xylem cell” configuration—where the Underground System is made massively parallel with multiple boreholes—in the hundreds or thousands. And internally, those boreholes could have either segmented cells, or be in in a unified structure as in FIG. 22. However, the advantage of each cell having its own source of compressed humid air will make the design more efficient.

FIG. 27 is an above ground “forest” of hydrogen producing “tree crowns” where water is pumped from the Underground System into the artificial leaves creating massive amounts of hydrogen and/or pure oxygen from “free” condensed water.

FIG. 28 is a conceptual cutaway drawing of the “artificial Xylem” version of the invention with 100-micron xylem inside the copper column instead of a solid column of water and the artificial leaf extension at the top of the column as described in FIG. 13.

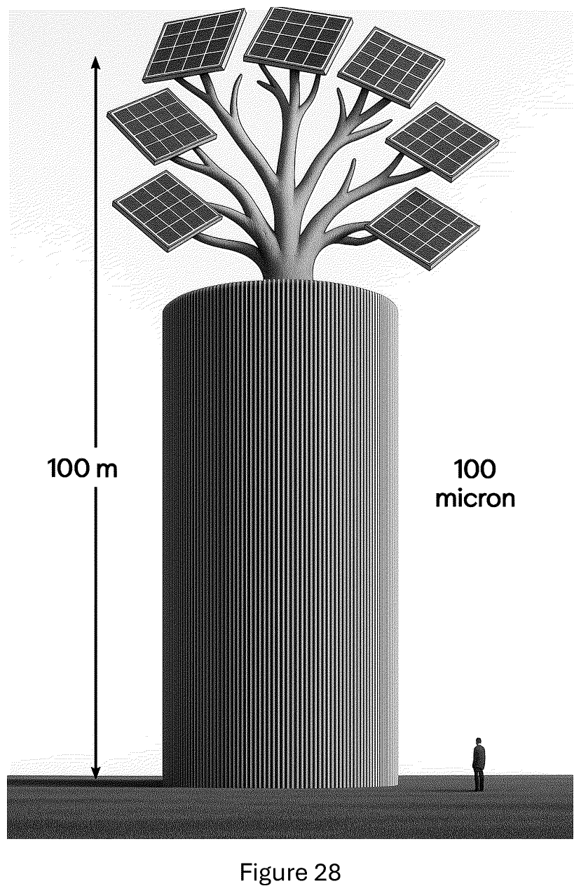

### DETAILED DESCRIPTION OF THE INVENTION

The world has constant water shortages. It's not worth going into those numbers but suffice to say that over 2 billion people currently live in areas with water scarcity or outright drought.

However, some of those drier areas (coastal areas along deserts, for example) actually have quite high humidity.

And here is another interesting fact: there are 3,400 trillion gallons of water in the Earth's atmosphere at any given time. And yes, that really is trillions with a “t.”

Or 3.4 quadrillion gallons. With a “q.”

Mankind's current inability to extract that humidity from the air and turn it into useful fresh water—means that basically Mankind doesn't have a lack of water problem. Mankind has a lack of ingenuity problem.

It is worthwhile to state that world-wide water shortages (on the ground) will continue to worsen for the foreseeable future for two reasons: population growth, and Climate Change.

Population growth will continue to increase the amount of water usage.

Climate Change will make it more and more difficult to keep water in lakes and reservoirs due to rising temperatures.

Changes and unpredictability in future rain patterns will further exacerbate the problem.

Additionally, a warmer atmosphere can hold more water. Meaning as global temperatures rise, more water will continue to evaporate, and less (fresh) water will be able to stay on the ground.

This means water will become more expensive, harder to access, and as time goes by, those without the economic means to obtain fresh water will inevitably have to make do with less-meaning future wars over water are probably inevitable.

In order to circumvent those problems and prevent those wars, inventions like that described in application Ser. No. 18/232,667, and the present invention, will become necessary to alleviate that water scarcity.

So the question posed by this application is the following: what if solving the problem of water scarcity worldwide was as simple as building a forest of copper columns, and using sub-surface temperatures to cool those columns?

How would that work?

Imagine a glass of ice water.

Everyone has seen water bead on the surface of a glass of ice water at a restaurant—or on a picnic table on a hot, humid summer day.

The amount of water you get from condensation on the surface of a glass of ice water is relatively small.

At best, you get a ring around the base of the glass before you lose your ice.

But what if that glass of ice water was 100 meters tall and six inches in diameter? And what if you could maintain a constant temperature on the surface of the glass 24 hours a day and 365 days a year?

What would happen?

What would happen is that in humid conditions, for that larger 100-meter tower, that “ring at the bottom of your water glass” would actually be over a hundred gallons per hour. The math will prove this below.

However, we won't be using ice water for this invention—only slightly chilled water—at 55 degrees Fahrenheit (12.78 degrees Celsius).

And we won't be using ice or any type of refrigeration to cool that water. Only subsurface temperatures.

Build enough of those columns (a hundred-plus gallons of water per hour times hundreds of thousands of columns) and you could create an unlimited supply of water—pretty much anywhere in the world.

The ideal environment for these columns is a humid environment (coastal marine environments are ideal). But in pretty much every environment (except for high altitude areas with consistently low humidity), some measure of condensation will form on the surface of a glass of ice water. Which means that condensation will also form on a slightly less cold—but a much larger—cylinder.

So a consistently cold column of metal, cooled by subsurface temperatures, means that no “ice” or “refrigeration” is actually necessary.

Water can condense on the surface of copper columns completely passively for the cost of a pump and a bit of geothermal cooling—basically forever.

There are several iterations of how this might be accomplished which are described below, but the main point of the invention, as in Ser. No. 18/232,667, is that basically subsurface temperatures are always 55 degrees Fahrenheit. And in an environment like San Francisco, the temperature differential between subsurface temperatures, and humid air coming off the Pacific Ocean, will create condensation. Make the chilled copper column tall enough (or wide enough—or numerous enough) and the amount of condensation will be quite massive.

So as stated above, in this invention you cool water using geothermal cooling, pump that cold water to the top of the column, and use the weight of that column of water and a bit of pumping to force water back into the ground in a continuous loop.

If you do so, it means (depending on the speed of the water flow) that the copper column will maintain a more or less constant temperature of 55 degrees Fahrenheit (12.78 degrees Celsius) in basically all external conditions.

To keep the pipe at 55 degrees on hot sunny summer days, you increase the rate of water flow. On cooler fall nights, you decrease the rate of water flow. And you take the rainy, stormy days as a win, because water will run down the columns in a continual stream and can also be collected.

Add a Tesla turbine to the bottom of the column to capture some of the gravity pressure from the weight of the water inside the column where the water heads back underground into the geothermal loop—and the electricity generated at that point in the invention can be used to partially power the pump which sends water back to the top of the column.

In ideal conditions, the pressure at the bottom of the 100-meter column of water will be 981 kPa or 142.3 psi.

If the 6-inch internal diameter of the column is decreased to a 1-inch pipe at the bottom of the column, the exit velocity of the water will be 44.29 m/s.

That stream of high-speed water can then be run through a Pelton, Turgo, or Tesla turbine which would create a theoretical max of 18.7-19.8 kW (Pelton), 17.6-19.4 kW (Turgo) or 5.5-12.0 kW (Tesla)—energy which is available continuously for use by the system.

In more practical terms, that means a daily maximum output from the turbine at the bottom of the column with a Pelton turbine will be 19.8 kW×24 h or 475.2 kWh per day. Which is enough to power 15-16 average homes continuously or run a 1,000-watt appliance nonstop for 475 hours. Not too shabby.

But let's run some actual numbers using actual equipment to get a more realistic idea of what we're looking at here.

Assume a Grundfos CR 255-2-2 A-G-A-E-HQQE¹ to pump water back to the top of the column. That pump has the following parameters: Max motor power: 110 KW. Max head: ˜400 m. Max flow: ˜390 m³/h (at lower heads). At a 100 m head, the CR 255-2-2 series typically operates efficiently at a flow range of 200-300 m³/h, with a power draw of ˜55-75 kW (motor output). ¹ https://libertysupply.com/products/lsikzye908

At the lower end, let's use a Pelton turbine which has an efficiency of 85% for energy recapture.

Given those parameters, let's use the following parameters: Flow rate: 250 m³/h (≈1,100 GPM). Head: 100 m. Pump output power ˜65 kW. Motor efficiency: 90%. Pump efficiency (pumping water to the top of the column): 85%. Turbine efficiency (capturing energy at the bottom of the column): 85%.

We can then use the formulas:

$$Power Input ( Pinput ) = ( 1000 \cdot 9.81 \cdot 100 \cdot 3600 / 250 ) / ( 0.85 \times 0.9 ) \approx 89.7 kW \\ Power Recovery ( Pturbine ) = ( 1000 \cdot 9.81 \cdot 100 \cdot 3600 / 250 ) \times 0.85 = 58.1 kW \\ Power net ( Pnet ) = 89.7 - 58.1 = 31.6 kW deficit$$

The number of kWh/day required to run the system then is: 31.6 kW×24=758.4 kWh/day

The cost to run the system is therefore: 758.4×$0.12 per kWh=$91.00/day at commercial pricing of $0.12 per kilowatt hour.

Those are just some basic numbers to pump 250 cubic meters of water per hour (1,100 gallons per minute) through the system. A rate of flow which should be sufficient to keep the temperatures inside the column very stable.

So it looks like it will take a bit of additional electricity input (from the grid or other sources) to achieve energy parity between the pump forcing water to the top of the column (energy expenditure) and the Tesla (or Pelton) turbine benefitting from the gravity assist and capturing the energy of water passing through the turbine at the bottom of the column (energy capture).

The costs, however, are less than $100 a day—which won't break the bank. And the reason the cost is so low is that not only are you recapturing some of your electricity spend as water descends the column, but you have completely eliminated the costs of refrigeration.

Add a solar or wind installation and you could easily cover that 758.4 kWh/day deficit.

However, a solar or wind power installation to cover that deficit would cost in excess of $150,000—so for smaller installations (one or two columns) it's probably better to just buy electricity from the grid.

But for larger installations, and in order to make the system truly independent, it's probably worthwhile to install wind and solar power at the start—and just pay off those power installations over time—by selling your water output.

Given some of the financial parameters below, solar and wind installations can actually be paid off quite rapidly—so are also worth including in initial startup costs for larger “condensation farms.”

For some revenue models (like selling water produced by the system as distilled water or selling the water to bottling companies), the system should theoretically be able to pay off even larger size wind or solar installations during the first year.

But the point of all the above is that the amount of energy required to run the system should be minimal and easily provided for by external wind or solar power—or relatively minimal additions to the system from the grid.

As mentioned above, the system has no refrigeration costs—so the only electrical cost is really the pump which runs water through the geothermal system and then back up to the top of the column.

Everything else in the system is either energy recapture-related or completely passive (condensation).

And therefore, the system should, with wind and solar power added, at least in theory be completely free to run over the long term.

In a humid environment such as San Francisco where average humidity is 75%, water should continually bead on the external surface of the cold copper.

And again, the overall cost of that system is basically a geothermal loop, the cost of the copper tower, a water pump, and a Tesla (or Pelton) turbine.

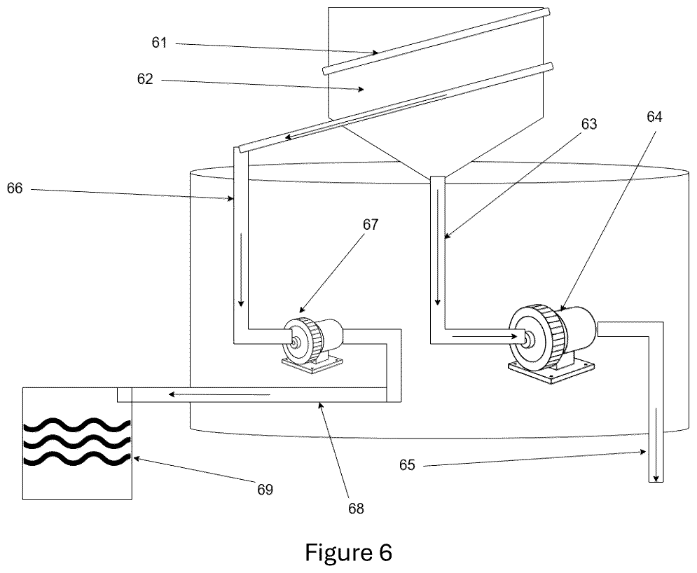

Additionally, it should be noted that in a two Tesla turbine (or two Pelton turbine) configuration, one Tesla turbine could be dedicated to energy recapture from the internal water column as discussed above. See FIG. 6, Item 64.

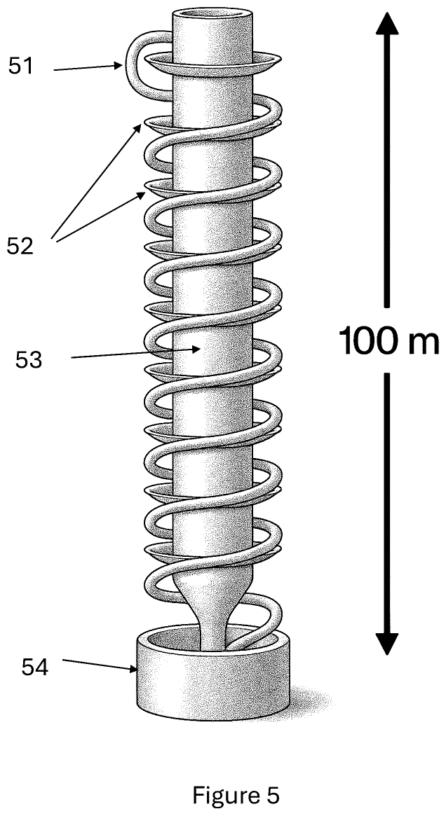

And if water reclamation from the surface of the column was ported through a series of tubes with shrinking diameters (to benefit from both the gravity assist and increased speed due to the Bernoulli principle), a second Tesla turbine could be dedicated to energy recapture from the water condensing on and falling from the column itself. See FIG. 5 as well as Items 61, 66, and 67 in FIG. 6.

The “height of the water column” in the smaller curving tube around the outside of the column means the water pressure won't be as high (plus it will take several meters to a achieve a constant flow of condensed water in that smaller tube) but the smaller gauge in that condensed water capture tube should provide a consistent “curved column” of water providing water pressures not to be sniffed at.

Why? Because that additional water pressure is “free” in the sense that a water droplet condensing at the very top of a 100-meter column must fall 99 meters to reach the ground—and every droplet that rolls down the column from that height, as well as every droplet that condenses on the column from every single height underneath that, carries a very small but (collectively) important bit of potential energy which can be captured. Each bead of water is like a raindrop. But collectively what we're capturing here is the power and energy of a continual 24 hour a day, 365 days per year micro-thundershower.

A “perpetual motion” water column? Perhaps not. You will probably always need to add a little bit of energy to the system.

But by capturing the hydro power of each water droplet that forms on the column, that means that the system probably is not too far off from being mostly free to run.

### Water Production

But setting the energy requirements/benefits of the system aside, let's take some actual numbers and figure out what we're looking at in terms of water production from a single 100-meter-tall column.

Assume a 6 in diameter copper pipe (with relatively thick walls for structural stability).

Build that copper pipe as tall as a Redwood tree (100 meters).

That would give you the following surface area:
Height: 100 m
External diameter: 6 inches=0.1524 m
Surface area (cylinder):

$$A = π \cdot D \cdot h = π \cdot 0.1524 \cdot 100 \approx 47.9 {m}^{2}$$

For the material of the column let's use copper pipe at an appropriate structural integrity to withstand normal weather conditions, so 12 mm thick.

Let's also coat the external AND internal copper with 10-micron Electroless Ni—P to prevent a patina from forming on the copper itself (a copper patina would greatly reduce thermal conductivity).

Electroless Ni—P is a higher quality coating used in marine environments. I've run the calculations, and the thickness of the copper (12 mm) compared to the relative thinness of the plating should provide only a minimal thermal effect, preserving copper's high thermal conductivity.

With those provisions, we can also state that the internal pipe temp will be a constant: 55° F.=12.8° C. because it will be filled with water cooled to that temperature by the geothermal loop.

That water will be constantly cycled through the geothermal loop at an appropriate speed to maintain that constant temperature. As per the calculations above with the Gundfros pump, that means 250 cubic meters per hour (or 1,100 gallons per minute) of cold water will run through the column. And that should more than do the trick.

The geothermal loop will be of sufficient size to handle that cooling in all external conditions (cold nights as well as hot summer days).

Let's also state for this experiment that the ambient air temp is 20° C.—a pretty typical day in San Francisco.

The average relative humidity for San Francisco over a typical year is: 75%

The dew point, under those conditions, using the Magnus Formula, is 17.1° C.

Given those parameters, condensation will occur on the pipe surface—as 12.8° C. is below the dew point of 17.1° C.

So then we can put the calculation together this way:

$$Surface Area = 47.9 {m}^{2} \\ Air temp Ta = 20 ° C . , \\ Relative humidity RH = 75 \% \\ Surface temp Ts = 12.8 ° C . \\ Latent heat of vaporization Lv \approx 2.45 \times 106 J / kg$$

### Water Vapor Saturation Pressures:

$$Psat ( 20 ) \approx 2.34 kPa \\ Pv = 0.75 \cdot 2.34 = 1.755 kPa \\ Psat ( 12.8 ) \approx 1.47 kPa \\ Δ P = 1.755 - 1.47 = 0.285 kPa$$

So given the above, we can use the typical mass transfer coefficient in the formula: \dot{m}=hₘ·A·ΔP where:

$$\dot{m} = Condensation rate in kg / s \\ {h}_{m} = Mass transfer coefficient in kg / {m}^{2} \cdot s \cdot kPa \\ A = Surface area in {m}^{2} \\ Δ P = Water vapor pressure difference ( air - surface ) in kPa$$

That leads to the following formula:

$$\dot{m} = {h}_{m} \cdot A \cdot Δ P = 0.0 \; 05 \cdot 47.9 \cdot 0.285 \approx 0.0683 kg / s or 0.0683 kilograms of water per second .$$

Per hour, that means: 0.0683·3600≈246 kg/h of condensed water or about 65 gallons per hour in ambient air conditions (natural convection) being produced through condensation on the outer surface of the copper column.

In addition, we can also recalculate the formula for the average wind speed in San Francisco (8 mph). Where hₘ has the following typical values: No wind (natural convection): 0.005. Light breeze (˜8 mph): 0.015. Strong wind (˜20 mph): 0.030.

So for “light breeze” (i.e. typical for San Francisco) conditions, we can use the following numbers: hₘ=0.015, A=47.9 m2, ΔP=0.285 kPa and with that you get the following formula:

$$\dot{m} = 0.015 \cdot 47.9 \cdot 0.285 \approx 0.204 kg / s$$

And then convert to hourly:

$$0.2 \; 04 \cdot 3600 \approx 734.4 kg / hour$$

Convert to gallons:

$$Gallons = Kilograms \times 0.264172 or Gallons = 734.4 \times 0.264172 = 194.007$$

Or about 194 gallons per hour with an 8-mph breeze.

Now that isn't half bad. 194 gallons per hour, times 24 hours, times 365 days per year=1,699,440 gallons per year. No, not kidding.

Just from one free standing Redwood-sized copper pipe somewhere in the San Francisco area.

Sure, you will lose some of that water to evaporation (though there are some ways to fix that described below). And temperature differentials will be different at night leading to less water capture during nighttime hours. But that is a kind of interesting number to contemplate.

Because what happens if you build 50,000 of those columns?

$$50 , 000 \times 1 , 699 , 440 = 84 , 534 , 000 , 000$$

That's 84,972,000,000 gallons more or less. Yes, that really is 84.9 billion gallons. With a “b.” Per year!

So that seems like a pretty good setup. Why? Because you've probably spent approximately the following amounts per column:

| Cost Component | Estimate (USD) |
|---|---|
| Raw copper (4,001 kg) | $38,010.00 |
| Welding + labor | $9,000.00 |
| Structural engineering | $4,000.00 |
| Anchoring/base system | $2,500.00 |
| Transport/handling | $2,000.00 |
| Contingency (15%) | $8,300.00 |
| Total | ≈$63,800 |

Add in the pumping equipment, some grounding for possible lightning strikes, a couple of Tesla or Pelton turbines for energy recapture, and with a few inevitable cost overruns, you've maybe spent $150,000 in all—as the large Gundfros pump described above retails for $47,323.95.

And if you sold that water as “distilled water” at $1.25 per gallon (US average) that one tower could produce a value of $2,124,300.00. Per year.

Ok, probably not quite that much, but still, that's not too shabby.

So it's worth building these, and building a lot of them. And building them pretty much everywhere.

Underground installations for geothermal cooling systems are well known, as are pumps which can push water up 100 meters of height (such as the Gundfros).

Include the geothermal installation, the pump, a couple of larger Tesla (or Pelton) turbines—one for energy capture from the internal water column as it heads underground, and a second for energy capture from the condensed water as it heads to storage or to water treatment—and with all the bells and whistles that means that maybe each tower costs $200,000, all in.

But if you massively scale this into a “forest” of columns, chances are you would have a single large industrial-sized geothermal installation. Which means you could also scale up to larger industrial-sized water pumps, and larger industrial-sized turbines for energy recapture. Meaning the cost of geothermal cooling and/or and pumps (energy expenditure) as well as turbines (energy recapture) should all scale and be combinable, reducing the overall cost per column.

Copper is an easy material to source and can be fabricated into the proposed shape with relative ease.

Water to initially fill the system is easy to come by and any water lost from the system—can be replenished by the system itself!

However, this first iteration of the invention system should have very little (systematic) water loss (from inside the system) to actually worry about. Fill it and forget it.

Copper pipes are well known for their stability and longevity in household plumbing. So even with a high volume of water flowing through the column from top to bottom at the rate of 250 cubic meters of water per hour (1,100 gallons per minute), 24 hours a day for decades should lead to very little maintenance, especially if the pipes are fabricated in 25- or 50-meter sections and require minimal soldering/welding. The thickness of the pipes (12 mm or thicker) should provide for additional longevity of the overall system.

So how about paying for the cost of the system?

Assuming San Francisco would pay you about $0.0258 per gallon, which is what they charge customers for delivery, wastewater, and stormwater for each gallon of water they consume—that's 1,699,440×$0.0258=$43,845.55 per year. Or about 4 years and change to pay off a single $200,000 column.

You could probably do quite a bit better selling water to a local water bottling company—say at $0.20 per gallon. Meaning you could pay off the tower in about 8 months (1,699,440×$0.20/365=$931.20 per day or $27,936 per month).

And if you sold the water as distilled water at $1.25 a gallon (1,699,440×$1.25/365=$5,820.00 per day)—each column would pay itself off in about 40 days. So what's really interesting here is if you add this configuration to the innovation of application Ser. No. 18/232,667. And enclose the copper tower in an insulated pressure sleeve.

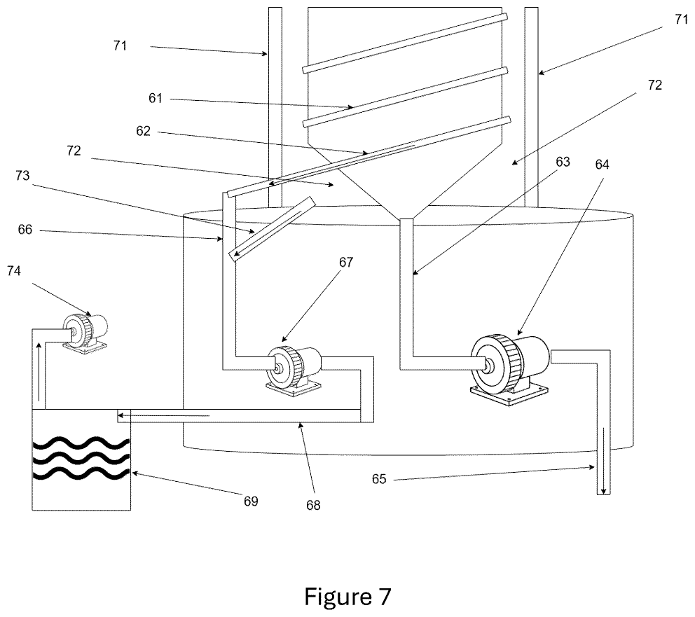

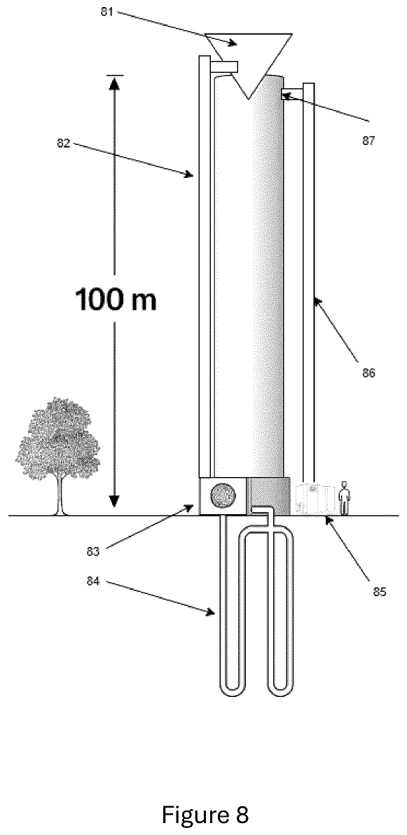

Then you force humid air down the sides of the copper column with a compressor. And if you do that, you can increase your condensation rate enormously. See FIG. 7 and FIG. 8.

Let's call the first system the “Open System” as the copper column is exposed directly to the air.

And let's call the second system with the additional pressure sleeve described below as the “Closed System.”

In each “Closed System” you add a dedicated Ingersoll Rand RS30i-A118-TAS compressor, capable of sending 184 cubic feet per minute down the column. And then you enclose the copper column in an insulated pressure sleeve located 5-10 cm from the surface of the copper column.

In that situation, with that higher rate of air from the compressor running down the inside of the pressure sleeve, you could theoretically increase water production from the “typical day in San Francisco number” of 734.4 kg per hour (in the Open System) to 982 kg/hour or 982×0.264172=259.4 gallons per hour (in the Closed System).

Meaning the Closed System could produce an annual rate of 259.4*24*365=2,272,344 gallons. Per year. Per column. Yes, really.

The Closed System here (using elements of Ser. No. 18/232,667) is probably the most efficient, because both the water condensing off the pipe (and accelerating via gravity) and the air pressure from the compressor—could both be combined at the bottom of the column for additional energy recapture. See Item 66 and 73 in FIG. 7.

That combined air and water pressure from the pressure sleeve can then be ported to a Tesla turbine at the bottom of the column to partially power the system (Item 67 in FIG. 7). That combination would allow recoupment of energy from both the water pressure (from water condensing on the column) as well as the excess air pressure from the compressor.

Meaning that with a pressure sleeve you would get a lot more water (and energy) out of the system, and for a minimal additional cost: the cost of a pressure-sealed sleeve, and a $35,000 air compressor.

Since air compressors can use sealed lines to get air to the top of the column, the compressor would also be relatively efficient in terms of energy.

### A Short Recap

All right. Let's recap. At this point you've got two configurations—a free-standing tower where water condenses on the outside of the tower because the temperature differential between subsurface temperatures (of water) inside the column and the external dewpoint (of humid air) will create condensation. The Open System.

And a second configuration where you have the same thing as above, but you add a pressure sleeve a short distance from the copper pipe, seal it at the top, and pump massive amounts of compressed humid air down and around the cooled copper column. That will increase your rate of condensation. The Closed System.

In both versions you capture the energy of the water inside the copper column as it runs through a Tesla turbine at the bottom of the system (Item 64 in both FIG. 6 and FIG. 7) before that water heads back underground into a geothermal loop.

Additionally, in both versions you can capture some of the energy of condensation as it rolls down the column.

In both the Open System and the Closed System, you can port the condensing water through a curving channel on the outside of the pipe (see Item 51 in FIG. 5, and Item 61 in FIG. 6 and FIG. 7) which can be ported to a Tesla turbine (Item 67 in both FIG. 6 and FIG. 7) for energy recapture.

Additionally in the Closed System, you can recapture some of the pressure contained inside the insulated pressure sleeve (Item 71 in FIG. 7) as it runs down through the pressure chamber (Item 72 in FIG. 7) adjacent to the copper column.

That excess air pressure then runs through the outlet at the bottom of the column (Item 73 in FIG. 7), combines with water pressure from condensed water (Item 66 in FIG. 7) and then both water and air pressure are ported back to a Tesla turbine (Item 67 in FIG. 7) for electricity generation.

So both the Closed System and Open System capture water pressure from the interior of the column.

And both capture the energy of “falling condensed water.”

And in the Closed System you additionally recapture some of the energy of the compressed air.

Call it an additional $50,000 for the “pressure sleeve” improvements and compressor—and it's still a win.

### Larger Scale Installations

What's interesting about this invention is what happens if you drop $2 billion into a “forest” of Open System columns.

At $200,000 per pipe (including geothermal installations and other costs) that means you could build 10,000 of these for each $2 billion spent ($2,000,000,000/$200,000=10,000).

And that “forest of falling water” towers would produce 1,699,400×10,000 or 16,994,400,000 or 16.9 billion gallons. Per year.

Or in the more efficient Closed System at $2.5 billion spent: 2,272,344×10,000 or 22,723,440,000 gallons per year. And yes, that is 22 billion gallons, with a ‘b.’

If you increased your spend for the Open System to $200 billion, that's 1.69 trillion gallons per year.

And if you increased your spend for the Closed System to $250 billion that's 2.27 trillion gallons. Per. Year. Basically forever.

And yes, that really is trillions. With a capital “T.”

1.69 trillion gallons from the Open System is only 1.4% of the United States entire annual water consumption (117 trillion gallons per year). But how many other inventions do you know of, other than rain, which can even approach a potential output of 1.4% of the annual water usage of an entire country—all for the cost of some simple materials and an interesting design?

The answer to that question, is zero. At least until now, anyway.

[symbol]

### Alternative Pump Configurations:

So at this point we have arrived back at the opening paragraphs of this application: our Open System “forest of 50,000 copper condensing pipes,” cooled by geothermal cooling, a pump pushing water to the top of each column, and water passing down the column (both on the exterior surface as condensation, and internally down towards the geothermal loop) which gets you back some of the electricity spend.

That seems like a fairly simple, easy to construct, and easy to understand invention.

And you have the second Closed System iteration where an insulated sleeve and a compressor can be added to the system to increase your condensation rate (as well as your rate of energy recapture).

However, it occurred to this inventor that Nature has already made a similar kind of system to raise water from ground level up to 100 meters of height without any type of pump at all: the Redwood tree.

A Redwood stands nearly 100 meters in height (300 ft), and yet it is somehow able to transport water from its roots, all the way to the crown, and does so completely passively.

How does it do so? Xylem. And transpiration.

“Xylem is . . . composed of elongated cells. Once the cells are formed, they die. But the cell walls still remain intact, and serve as an excellent pipeline to transport water from the roots to the leaves. A single tree will have many xylem tissues, or elements, extending up through the tree. Each typical xylem vessel may only be several microns in diameter. . . . The physiology of water uptake and transport is not so complex either. The main driving force of water uptake and transport into a plant is transpiration of water from leaves. Transpiration is the process of water evaporation through specialized openings in the leaves, called stomates. The evaporation creates a negative water vapor pressure . . . in the surrounding cells of the leaf. Once this happens, water is pulled into the leaf from the vascular tissue, the xylem, to replace the water that has transpired from the leaf. This pulling of water, or tension, that occurs in the xylem of the leaf, will extend all the way down through the rest of the xylem column of the tree and into the xylem of the roots due to the cohesive forces holding together the water molecules along the sides of the xylem tubing. (Remember, the xylem is a continuous water column that extends from the leaf to the roots.) Finally, the negative water pressure that occurs in the roots will result in an increase of water uptake from the soil.² ² https://www.scientificamerican.com/article/how-do-large-trees-such-a/

So nature has already created a system which draws water from the soil, up large columns of wood, and does so through root pressure, capillary action, and transpiration.

The inventor wondered if it would be possible to do the same thing artificially.

“Vessel elements are joined end-to-end through perforation plates to form tubes (called vessels) that vary in size from a few centimeters to many meters in length depending on the species. Their diameters range from 20 to 800 microns. Along the walls of these vessels are very small openings called pits that allow for the movement of materials between adjoining vessels.”³ ³ Ibid.

Up until recently, it has been impossible to manufacture tubes from 20 to 800 microns. However, Nippon Electrical Glass can now produce glass tubes 30 mm in length and anywhere from 132 up to 600 microns, meaning it is now theoretically possible to create artificial “man-made xylem” for industrial applications.

In other words, by connecting a series of artificial xylem inside the column, it should be possible to draw water from the base of the system, and up through the column in at least a partially passive manner. Just like water is drawn up from ground level to the crowns of trees.

You can improve also on Nippon Electrical Glass's tubes—which might not be ideal in a copper column continually flexing in the wind—simply by using 3d printing.

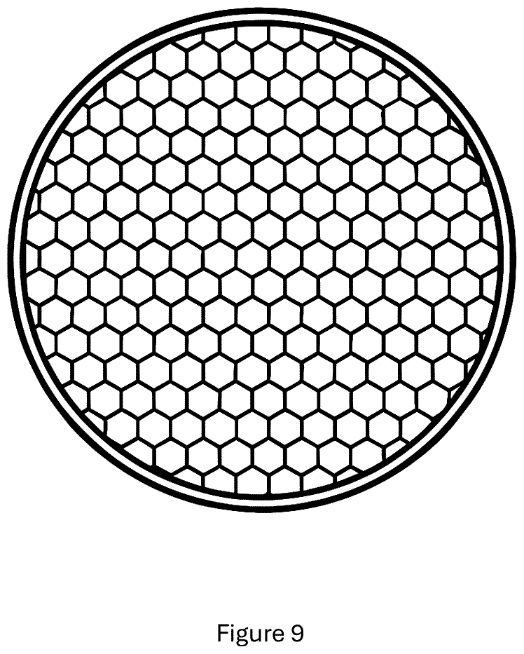

In other words, it should be possible to print an entire pipe section with integrated hexagonal-shaped “man-made xylem” of 100 microns. See FIG. 9.

Internally you would print the xylem at 100 microns and then as you were printing, close the end of each xylem cell and leave a small hole. That leaves a kind of “resting level” for the water before it is drawn up further in the tube through capillary (and stomatic) action.

This is analogous to the structure of xylem cells in a tree—where each xylem cell structure is closed—but has “perforation plates” at each end with small perforations called “pits” to allow small amounts of water to flow upwards between adjacent cells.

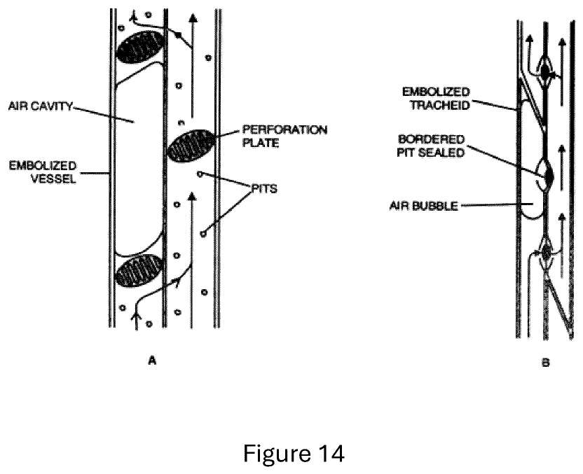

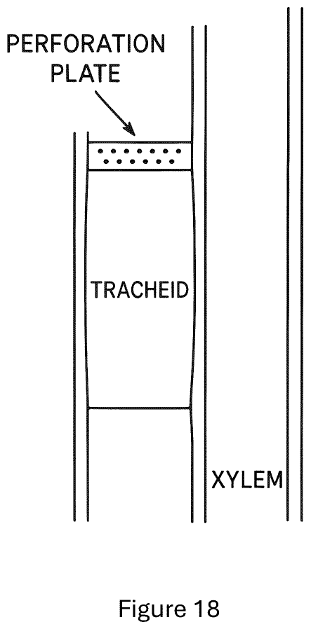

You can see from the structure of tracheids (FIG. 14) that water is transferred between cells at the perforation plate. A perforation plate is where two cells meet to transfer water and other nutrients. Also see FIG. 18.

This transfer can be accomplished either with a “simple perforation plate” (1 hole) or a “compound perforation plate” (multiple perforations).

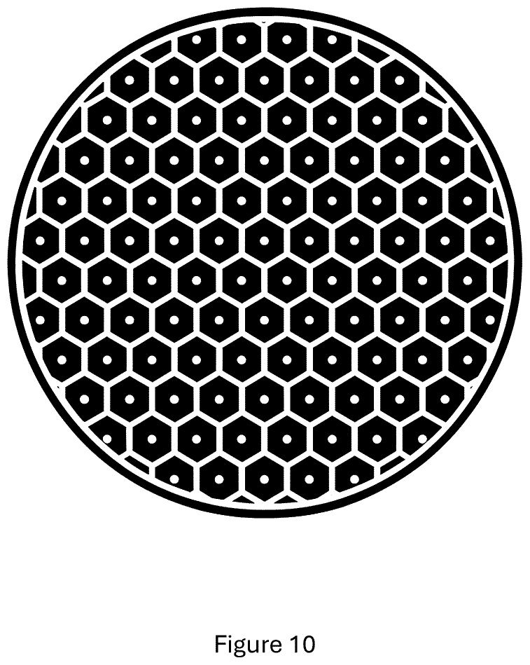

The iterations here in FIGS. 9 and 10 of “man-made xylem” are of the “simple perforation plate” variety but compound perforation plates are also possible.

What that means in very practical terms is—you either print sections of pipe with hexagonal (or circular) tracheids, or you lay long bundles of what is (conceptually) a lot like hollow fiber optic cable (5-125 microns in diameter) which will do the same thing. The tracheids will either need to be stable (3d printing in a hexagonal shape) or have the equivalent of fiber-optic cable flexibility to resist column flexing due to wind.

So, what do we have at this point? We have the first iteration of the invention, the Open System, which is a free-standing installation of a copper column. That water is chilled by sub-surface temperatures pumped to the top of that column. That cool water descends the column back towards the ground, and condensation forms on the external surface of the copper column. Condensation descends along the surface of the column and is collected at the bottom of the column.

And we also have an insulated version of the same, the Closed System, using compressed air to accelerate water production.

And here we have a similar configuration—at least externally.

But internally, instead of cold water descending the column, here cold water ascends the column using artificial xylem. The pump is excluded or partially excluded, or a lower throughput pump is used as a substitution for a Redwood's natural “root pressure.” We can call this iteration “the Xylem System.”

Capillary action causes water to rise through “man-made xylem” and reduces the energy requirements of raising water up the column. And water rises up the column in the same way Redwoods have been accomplishing that task for 240 million years.

To calculate the height of a “pump free” rise of water through capillary action at standard atmospheric pressures, we can use Jurin's Law: h=(2*γ*cos θ)/(ρ*g*r)

Where:

$$γ = surface tension of water = 0.0728 N / m \\ θ = contact angle = 0 ° ⇒ cos ( θ ) = 1 \\ ρ = density of water = 1000 kg / {m}^{3} \\ g = gravitional acceleration = 9.81 m / {s}^{2} \\ r = radius of the straw = 100 microns = 1 \times 1 {0}^{- 4} m$$

Substitute into the equation:

$$h = ( 2 \times 0.07 \; 28 ) / ( 1000 \times 9.81 \times 1 \times 1 {0}^{- 4} ) = 0.1456 / 0.0981 \approx 1.48 meters$$

And if we reduce the size of the straw to 50 microns and use the same formula:

$$h = ( 2 * γ * cos θ ) / ( p * g * r )$$

### Where:

$$r = radius = 50 microns = 5 \times 1 {0}^{- 5} m$$

Substitute those figures into the equation and we get:

$$h = ( 2 \times 0.07 \; 28 ) / ( 1000 \times 9.81 \times 5 \times 1 {0}^{- 5} ) = 0.1456 / 0.004905 \approx 29.7 meters$$

So at that point, you could theoretically create a column 29.7 meters in height where no pumping at all is required.

That is the magic of xylem.

The only missing part here is the inclusion of evapotranspiration to draw the water up the column to an even higher level.

“To move water through these elements from the roots to the crown, a continuous column must form. It is believed that this column is initiated when the tree is a newly germinated seedling, and is maintained throughout the tree's life span by two forces—one pushing water up from the roots and the other pulling water up to the crown. The push is accomplished by two actions, namely capillary action (the tendency of water to rise in a thin tube because it usually flows along the walls of the tube) and root pressure. Capillary action is a minor component of the push. Root pressure supplies most of the force pushing water at least a small way up the tree. Root pressure is created by water moving from its reservoir in the soil into the root tissue by osmosis (diffusion along a concentration gradient). This action is sufficient to overcome the hydrostatic force of the water column—and the osmotic gradient in cases where soil water levels are low. Capillary action and root pressure can support a column of water some two to three meters high, but taller trees—all trees, in fact, at maturity—obviously require more force. In some older specimens—including some species such as Sequoia, Pseudotsuga menziesii and many species in tropical rain forests—the canopy is 100 meters or more above the ground! In this case, the additional force that pulls the water column up the vessels or tracheids is evapotranspiration, the loss of water from the leaves through openings called stomata and subsequent evaporation of that water. As water is lost out of the leaf cells through transpiration, a gradient is established whereby the movement of water out of the cell raises its osmotic concentration and, therefore, its suction pressure. This pressure allows these cells to suck water from adjoining cells which, in turn, take water from their adjoining cells, and so on—from leaves to twigs to branches to stems and down to the roots—maintaining a continuous pull.⁴ ⁴ Ibid.

So to accomplish this, there are several possible options to mimic evapotranspiration.

One is to use a pump at the top of the column (to create a slight vacuum) to assist the movement of water up the column (the easiest option).

In that configuration you would substitute pumping for evapotranspiration.

In other words, water would partially (and at relatively little electrical cost) be drawn partially up the column through capillary action due to artificial xylem forming the internal structure of the column.

Pumping would accomplish the rest. As mentioned above, pumping could be done at the bottom of the system (to mimic root pressure), or by creating a partial vacuum at the top of the column (analogous to evapotranspiration).

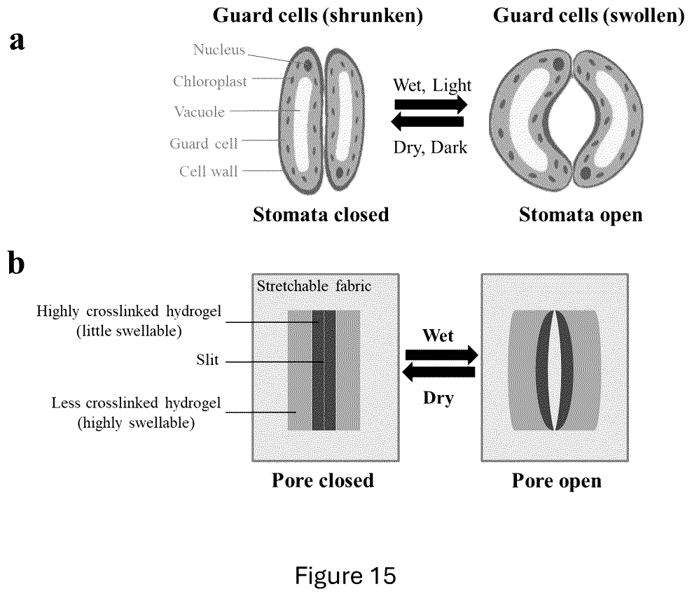

Another possibility is to use Water Responsive Fabrics at the top of the column. See FIG. 15. With water responsive fabrics, artificial stoma would release water vapor in the presence of heat (or sunlight), creating evapotranspiration.

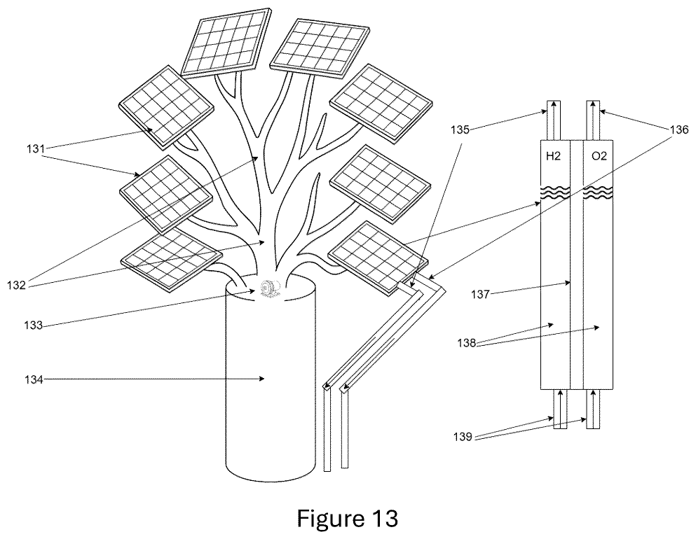

An additional possibility is to create “branches” at the top of the column. In that configuration, branching thinner copper pipes exit the top of the column, and then, in turn, lead to “artificial leaves” of solar panels. See FIG. 13.

There are several types of artificial leaves available, though for the current application, this one from the Swiss Federal Institute of Technology: https://www.youtube.com/watch?v=6YyUa-a5iBs as well as the system in the footnote would be good options.⁵ Both produce hydrogen and oxygen from water hydrolysis and sunlight. ⁵ https://news.mit.edu/2011/artificial-leaf-0930

Hydrogen and/or oxygen produced by those kinds of “artificial leaves” could be captured and burned as a “free” energy source by an electrical generator at the bottom of the column.

Alternatively, that pure hydrogen and oxygen could be stored or sold.

The water (from condensation along the outside of the copper column) is also free. So in theory anyway, with a bit of hydrogen production at the top of the system, the partially “free upward draw” of the “man-made xylem” and a bit of pumping (to substitute for root pressure and/or partially for transpiration), you actually have the beginnings of not only a very low energy water production system but also a “perpetual motion” system—which, with a bit of sunlight, produces its own fuel (hydrogen) to use in electrical generation and captures “free” water from the atmosphere via condensation—water which can be ported into the system itself. In such a system there will still likely be an enormous amount of excess for downstream consumption—excess water on the one hand (water production) from condensation and/or energy from captured hydrogen (used in energy generation—either by the system, the grid, or a plurality of other uses).

This “xylem” version of the invention is the most exotic, but perhaps also the most exciting—because it is more or less entirely passive, creates water (from condensation), powers the electrical components with “free” electrolyzed hydrogen, and basically can do that forever with very little maintenance and only a few moving parts. Just like a Redwood tree.

Whichever configuration ends up being more widely used, as with application Ser. No. 18/232,667, “The Hanson Deep Bore Water Production System for Mountainous Coastal Environments” it's not a one-column system which is going to do the trick—but rather the ease with which you can make the invention massively parallel.

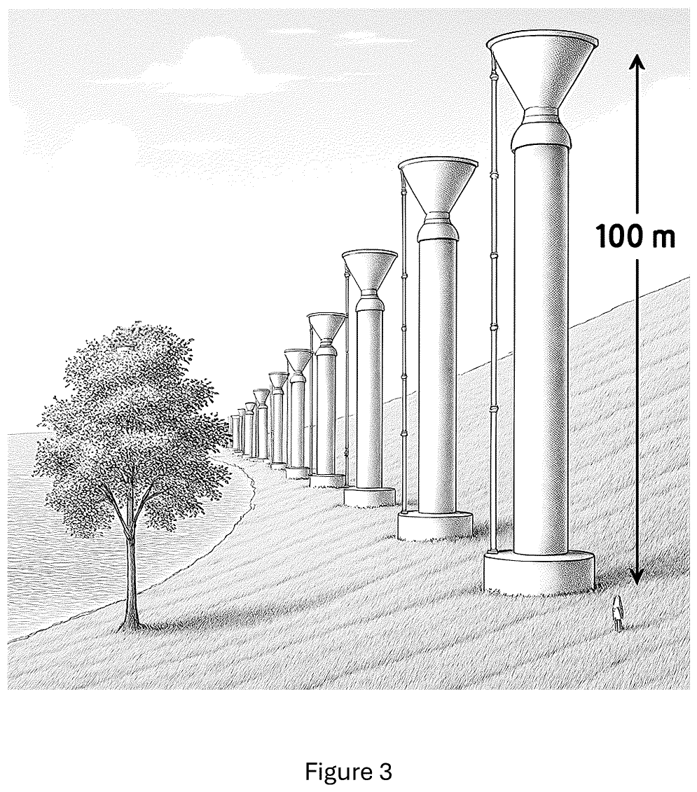

Like the image in FIG. 3—where you have large installations of columns, or “water production system forests” if you will. And all you really need to do is locate those “water production forests” in areas with sufficiently high humidity to make the invention viable. Anywhere near an ocean or a large body of water will do quite nicely, thank you.

### Additional Formats of the Invention

One final step in this process is to consider other shapes, formats, or orientations in which the overall invention could be utilized.

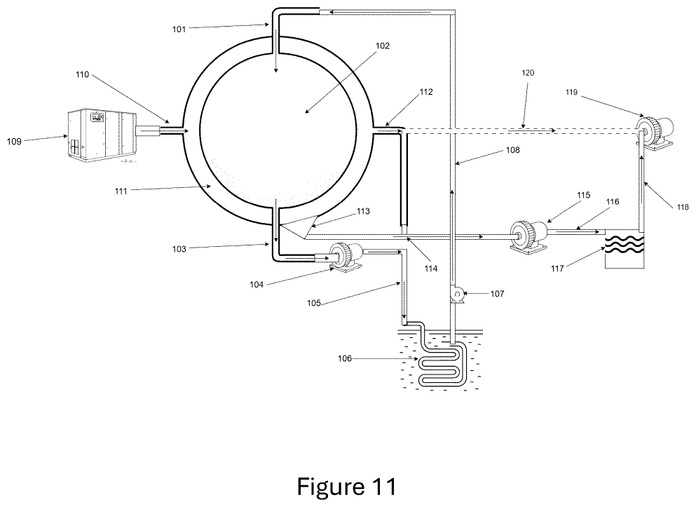

One interesting possibility is a sphere—which for the same surface area as the 100-meter column (47.9 m²) would require a sphere only 3.904 meters in diameter (4πr2=47.924⇒r2=4π47.924≈3.813⇒r≈1.952 m). See FIG. 11. Let's call this iteration “The Spherical System.”

In the Spherical System, you would lose some of the practical features of the Open System (the weight of the internal water column, the gravity assists and gravity-powered acceleration of condensed water on the exterior of the column)—but at the same time the Spherical System becomes far more practical from a fabrication and installation standpoint. In other words, a giant egg (low to the ground) versus a giant free-standing column.

You still can have an external “pressure sleeve” around the sphere and benefit from the compression of moist humid air that you get in a Closed System, as well as still get some of the energy recoupment features by using spare air and/or water pressure from inside the pressure sleeve to power a secondary Tesla turbine.

Additionally, since the Spherical System's interior volume (31.2 cubic meters) vs. the column's interior volume (1.29 cubic meters) is quite different, the amount of water cycled through the sphere to keep the temperature of the water a constant 55 degrees Fahrenheit would be substantially decreased.

Also, the gravity penalty and electricity costs of lifting water 4 meters off the ground (sphere) vs. lifting water 100 meters off the ground (column) is also quite different.

In practice, both the Open System and Closed System columns will require higher internal water speeds for industrial scale water production and by extension have higher energy costs.

By contrast, the Spherical System would be lower to the ground, be easier to maintain, and require less powerful pumps and use less energy overall. One downside of the Spherical System however is that it would have a larger overall surface footprint.

Both iterations (Open System, Closed System, and Spherical) should be viable (and reliable) water producers, however.

Additionally, if the Open System and Closed Systems versions of the invention were installed at a 45-degree angle on a mountainside, they would still benefit from 70% of the height of the water column: h=100·sin (45°)=70.71 meters. These tilted systems (as they run along the ground) would be far easier to maintain and could also be made far longer than 100 meters. Let's call this one the “Fallen Tree” version.

In the “Fallen Tree” version, if hydrostatic pressure is P=ρgh, where ρ=1000 kg/m3 (density of water), g=9.81 m/s² (acceleration due to gravity), and h≈70.71 meters, you get a formula like this: P=1000·9.81·70.71≈694,661 Pa=694.7 kPa of pressure at the bottom of the column, which isn't quite as good as the 981 kPa you get from a vertical 100 meter column, but it's still pretty good.

That translates into a jet exit velocity at the bottom of the Fallen Tree version with a 1-inch pipe of 37.3 m/s which translates into 13.1 kW. Or at 85% efficiency with a Pelton turbine, 11.1 kW or 266.4 kWh per day. Not quite as good as the free-standing column, but you're not pumping water to quite the same vertical height either.

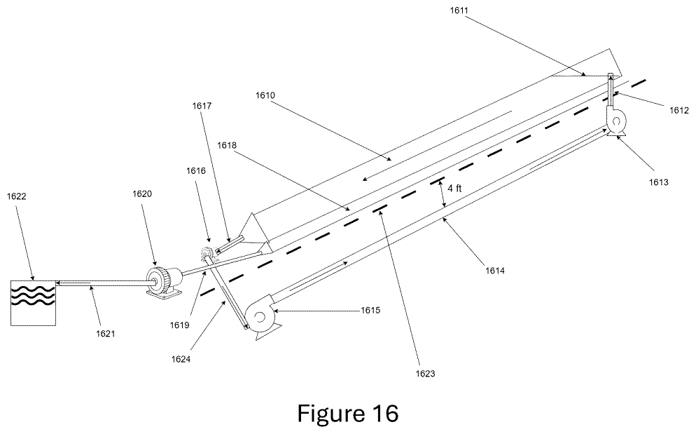

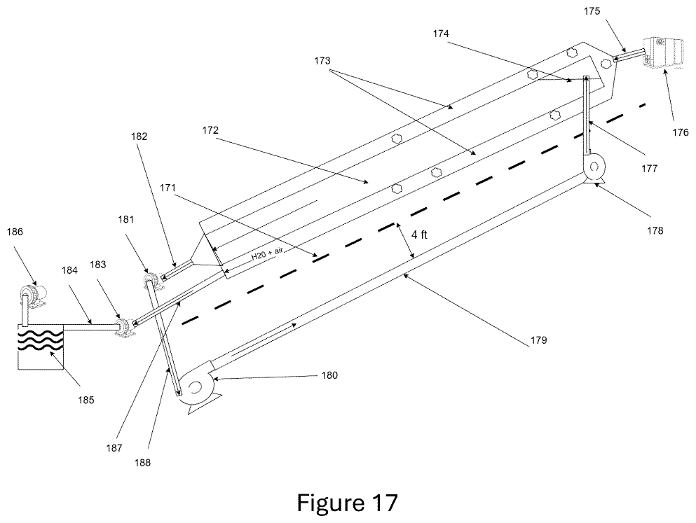

FIGS. 16 and 17 give a visual representation of those “reclining mountainside” or “Fallen Tree” systems. Let's call those the “Fallen Tree Open”, and “Fallen Tree Closed” systems.

What's interesting about the Fallen Tree systems is that they closely resemble the initial Ser. No. 18/232,667 application. But here instead of pumping compressed humid air below ground, you have water which is sent below ground to cool, and an above-ground (and/or pressure-sleeve-enclosed) copper column instead.

In both cases, whether “Fallen Tree Closed” (with a pressure sleeve) or “Fallen Tree Open” (without one), the geothermal loop saves an enormous amount of energy and money on refrigeration costs as those underground subsurface temperatures are essentially free.

Additionally, the Closed System, or Closed Fallen Tree system could be put entirely underground and benefit from what is effectively “double sleeving” of the invention. Let's call this one “The Underground System.”

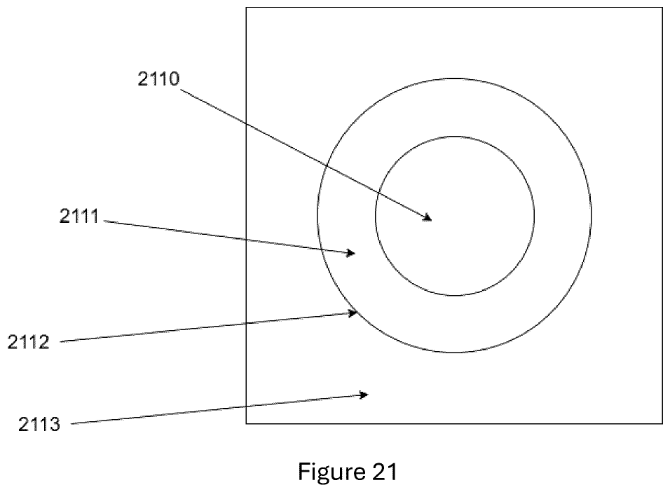

What I mean is the following. In FIG. 21 you have a top-down view of “The Underground System.” where at 2110 you have the geothermally cooled water filled column, at 2111 you have the pressure chamber, and at 2112 you have the outer wall of the pressure chamber. Except this time the outer wall of the pressure chamber at 2112 isn't insulated on the outside (as it would be with a free-standing vertical column in the air).

Here the wall of the pressure chamber is underground. And it is clad in copper.

And since that pressure chamber wall is actually underground (at 2113) and the copper is in direct contact with the ground (or bedrock) that means that the pressure wall at 2112 is ALSO cooled by geothermal temperatures—to 55 degrees Fahrenheit.

What that means is that both the inner column (filled with geothermally cooled water) and the outer copper wall of the pressure sleeve (geothermally cooled by direct contact with the ground) are BOTH geothermally cooled.

So now we have an inner column cooled with geothermally cooled water to 55 degrees Fahrenheit. And an outer pressure sleeve (also made of copper) which is ALSO cooled to 55 degrees Fahrenheit.

So conceptually the (now underground) column is 100 meters long, with a surface area of 47.9 square meters.

If the pressure sleeve leaves an additional 6 inches on either side of the column (for a total of 18 inches in diameter), you would need to support the internal water column with struts or supports so that it hangs freely inside the space between the outer walls of the pressure chamber.

Add 5 meters to the top and 5 meters to the bottom of the outer pressure sleeve for support beams and maintenance areas.

Meaning you have an internal 100 meter tall, 6 inches in diameter water cooled column supported by struts inside of a 110 meter long, eighteen-inch-wide pressure sleeve.

We already know the surface area of the internal column: 47.9 square meters.

The formula for the internal surface of the pressure sleeve is the following. The surface area of a cylinder is A=2πrh, meaning A=2π(0.2286)(110)≈2×3.1416×0.2286×110≈157.992 square meters.

Add the end caps (Area of each end=πr2, Total ends=2πr2) which means you get 2π(0.2286)²≈2×3.1416×0.05225796≈0.3283 square meters or Lateral+Ends=157.992+0.3283≈158.32 square meters of internal surface area for the pressure sleeve.

Now if we add in our original 47.9 square meters from the geothermally-cooled water column, you get 47.9+158.32≈206.22 square meters of surface area—all of which will remain at a constant 55 degrees Fahrenheit. Which is 4.3× the original surface area of just the water-cooled copper column alone.

Meaning that in the “Underground Configuration” you could pump a lot more compressed air into the space, and get a lot more water out of the system—as you would have 4.3× the amount of geothermally cooled surface area to play with: 47.9 meters of water-cooled surface area via a geothermal water loop plus 158.32 square meters of “direct contact with the bedrock” geothermally cooled copper surface area.

At that point the engineering limits of your compressors start to come into play, particularly at larger scales. But 4.3× the Closed System numbers—2,272,344 gallons per year×4.3=9,771,079 gallons per year per installation is kind of interesting—just for the cost of dropping the whole invention down a hole.

But what's even more interesting here with the Underground System is that since the whole thing is underground, it becomes far easier to support versions far larger than a 100-meter tall 6-in in diameter free-standing column.

What I mean is that in the Underground System, with support beams holding the inner geothermally cooled water column in place, equidistant from the walls of the pressure chamber, you can run as many support struts or I-beams as you need right into the bedrock.

Those support struts or I-beams could run directly from the bedrock, through the outer wall of the pressure sleeve, and since those support columns are also embedded in bedrock, they would create ADDITIONAL cooling surface area (i.e. the collective cooling surface of hundreds of meters worth of I-beams.)

Those support struts or I-beams could actually be partially repurposed, wrapped around the central column, and provide water channels for condensation falling down the side of the internal column, while also providing columnar support.

What I'm getting at is the here is the SIZE of the invention can be made massively larger. One big installation, instead of many smaller ones.

For example if, instead of 6 inches, you bored a silo-shaped shaft into the ground, and made the external diameter of that shaft 12 meters, and went to a depth of 310 meters, that would create an external surface area for the pressure sleeve of Atotal=Alateral+Aends=11,686.0+226.2=11,912.2 square meters.

Add the surface area of the internal column filled with geothermally cooled water and leave 2 meters on each side (for maintenance) and 5 meters at the top and bottom of column for support beams and maintenance spaces—and you would have a column 8 meters wide and 300 meters long. That geothermally cooled water column would be “hanging in the air” (though supported by struts) in the middle of the pressure sleeve, creating an additional Atotal=Alateral+Aends=7539.82+100.53=7640.35 square meters of space available for condensation.

So if you add those two together (the surface area of the silo's external pressure wall and end caps plus the external surface of the “floating” column), you get 11,912.2+7640.35=19,552.55 square meters of surface area. ALL of it geothermally cooled.

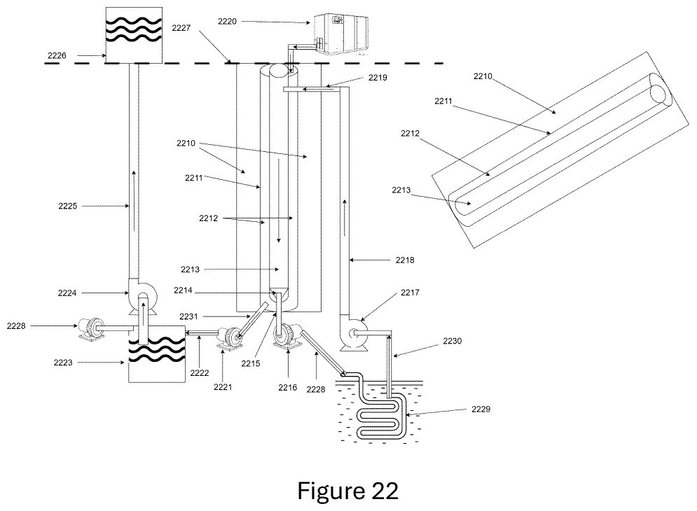

Again, the outer wall of the copper pressure sleeve is cooled by direct contact with subsurface temperatures (the silo walls). And the internal column is cooled by geothermally cooled water pumped through a geothermal loop). See FIG. 22.

What's really interesting here is if you go back to our original 100-meter column. That column is 6 inches wide. That initial version gives you 47.9 square meters of surface area.

The Underground Version gives you 19,552.55 square meters of surface area. A factor of 408× vs. the above-ground version of the Closed System. And this is something that is actually feasible from an engineering standpoint.

I'm not going to go through the calculation of how much potential water that is. Only to say . . . it's a lot. Somewhere in the ballpark of 408 times 2,272,344≈927,116,352 gallons per year. Per installation. More or less, provided you can figure out the compression and water-flow issues associated with scaling the invention to something like that size.

So, now for the fun part—mix and match. And extrapolate.

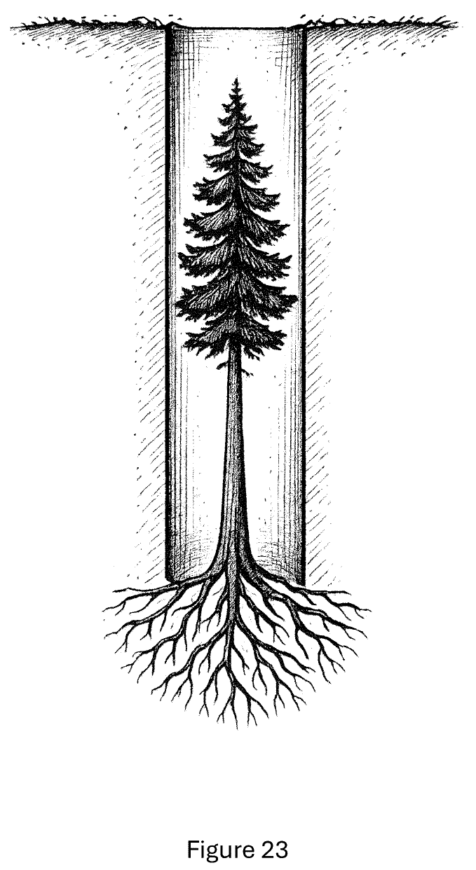

Conceptually, what we've done with the Underground System is drop a Redwood tree down a hole. FIG. 23.

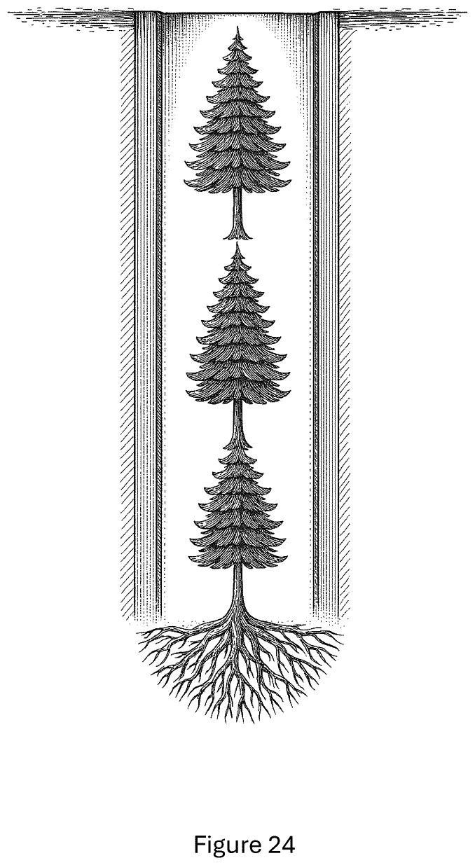

Then you can stack those Redwood trees one on top of each other. FIG. 24.

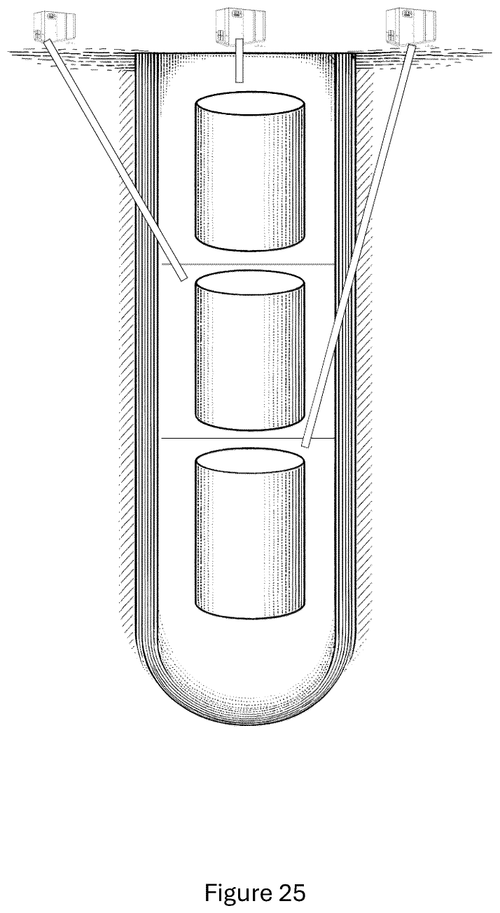

Transform those Redwoods into our water-cooled columns and use the Underground System as a kind of Xylem Cell—and stack one Underground System on top of another. Where you have the massive 12 meter bore hole—but you have a series of Underground Systems, one on top of each other, down to a depth of 500 meters. Or more. With multiple compressors feeding humid air down from the surface. FIG. 25.

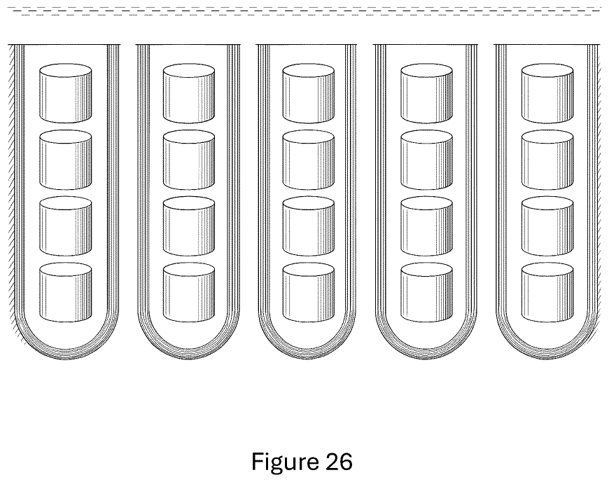

Then make that whole thing in FIG. 25 massively parallel. Creating an “underground forest” of stacked Underground Systems. FIG. 26.

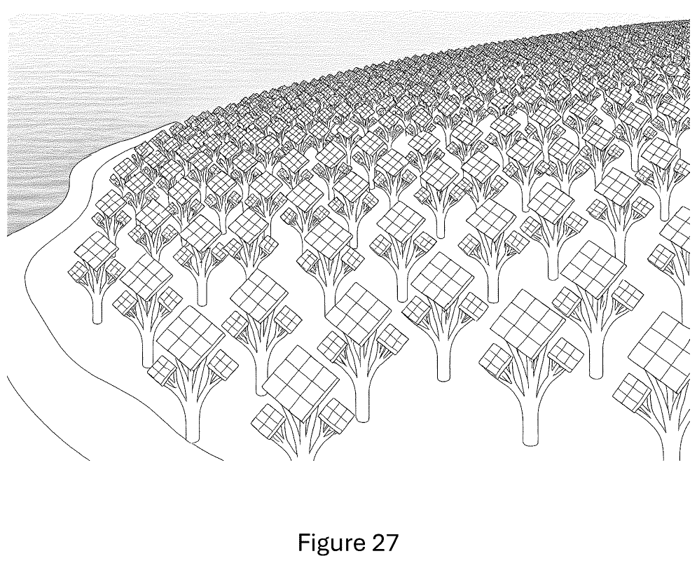

And then, even more ridiculous (and awesome) entire “forests” of artificial trees on the surface—sporting artificial leaves, easily maintainable (as they are at ground level) and all of them (in a sunny environment) producing massive amounts of free hydrogen—from sunlight, and from water you pump from underground—water which is not from a well or aquifer, but water farmed from humid air via geothermal cooling and the innovations this invention brings to the table. Massive amounts of water, converted to hydrogen more or less passively—and that hydrogen can then be used to generate electricity to power the entire system—or that hydrogen can ported to a variety of other uses—like powering cars, or machinery, or planes, or trains. Water farmed from humid air—powering the world. And, at scale, eliminating the need for fossil fuels entirely. FIG. 27.

The final step in all of this is to imagine this system encased in other real-world applications.

One possibility is to put the system in a telephone pole or light pole—or both. There are approximately 1.8 billion to 2.2 billion light and telephone poles (combined) worldwide. Each of those poles has an average height of 11 meters, and an average diameter of 0.3 meters (30 centimeters).

So going back to the surface area of a cylinder: A=2πrh, that means a formula like this where the surface area of an average telephone and/or light pole (Apole) is

$$Apole = 2 π \times 0.15 \times 11 = 10.37 m 2.$$

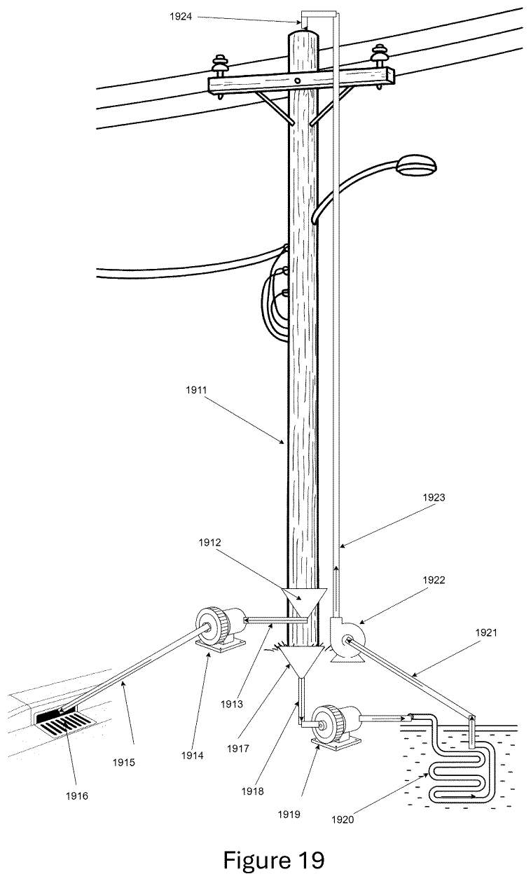

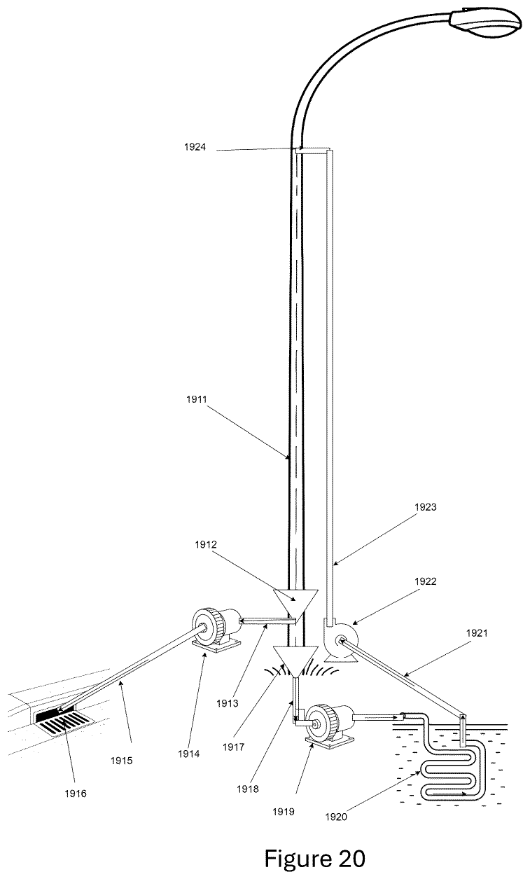

Multiply that surface area per pole by 2 billion poles worldwide (more or less) and you get Total Area (Atotal) which is Atotal=10.37 m²×2,000,000,000 ˜ 20.74 billion square meters. That is about 8,000 square miles of total surface area, or approximately the size of the entire State of Massachusetts. Let's call this the “Telephone and Light Pole” version. See FIG. 19 and FIG. 20.

So if you do a bit of additional math, that means that if you slowly, over time, replace all of the telephone poles in the world with this system, and just dumped the water from those light and telephone poles into the sewer system for later reclamation, that would produce quite a bit of water.

If all of those poles were in high humidity areas, that would be 2,000,000,000 square meters of surface area/47.9 (the square meters for the 100-meter column “Open System” version) and you would get 41,753,653 times the numbers described in this application for a 100-meter pole Open System or: 1,644,900×41,753,653=68,680,583,819,700. Or 68.6 trillion gallons. Or 260,010,835,320 cubic meters of water. Per year.

Relative to the usage of water worldwide, which is 4.3 trillion cubic meters (4,300 cubic kilometers)—it means that simply by placing this invention worldwide inside telephone poles and light poles you could generate about 1/16^{th} or 6% of WORLDWIDE water consumption.

Even if you only get a fraction of that (the world does have a lot of dry areas), that still is a pretty significant number of gallons of water—which would stabilize the global water supply. Worldwide. Forever. Just from telephone and light poles. And who knows where else you could put the invention? Once you see the invention and understand it, you will start to see it everywhere it might do some good.

And with that, we've come full circle back to the beginning of this invention—50,000 copper pipes lit by the morning sun and glistening with condensation—and here, at the very end of the journey, we've taken that initial image one step further: porting the invention worldwide into 2 billion light and telephone poles—all doing the same thing: condensing water from the atmosphere, day in, and day out, across a surface area the size of Massachusetts.

And if the numbers here seem completely outlandish, just imagine a spring or summer morning, with dew condensing on the grass. And that dew soaking your shoes as you walk across it.

Now imagine that small field of grass you just walked through mentally.

But that field is as big as the entire state of Massachusetts.

How many gallons of water is that? Yep. A lot.

### CONCLUSION

So whether as a completely passive system with copper exposed (The Open System), or a system similar to the Hanson Deep Bore Water Production System with an external pressure wall (The Closed System), or in other possible configurations (like The Spherical System), or having the entire system tilted on its side along a mountainside (the Fallen Tree Open or Fallen Tree Closed systems), or set underground (The Underground System—in a “solitary,” “stacked,” or “underground forest” configuration) or in every telephone and light pole worldwide (the Telephone and Light Pole system); and regardless of how the internal column is chilled (passive xylem or active pumping), the Hanson Redwood Xylem Water Production System should be a good long-term solution to the water needs of the Nation, and of the World, for centuries to come.

1. A water production system comprised by a copper column topped by a water reservoir and wherein that copper column is hollow yet thick enough for stability in a variety of weather conditions and via that thickness retains the thermal properties of the copper even with patinas or electroplating; that column is then filled completely with geothermally cooled water which travels down from the top of the column and through the column to a funnel at the lower end of the column, a funnel which gradually diminishes in diameter leading to a pipe of sufficiently small diameter to take advantage of the Bernoulli principle which accelerates that water, and wherein that column is of sufficient height to create pressures capable of electrical generation; that pipe at the bottom of the column of water in turn is attached to a first Tesla turbine which captures energy from the water flowing through it and that energy can be used to offset the overall energy requirements of the system; that water then travels from the first Tesla turbine through an underground geothermal loop which reduces the temperature of the water to 55 degrees Fahrenheit; that water is then pumped from the geothermal loop up to the top of the column utilizing a pump partially powered by energy from the first Tesla turbine, solar panels, wind, or grid power; and that water once pumped back to the reservoir at the top of the column completes the cooling cycle of the system; and the geothermally cooled water at 55 degrees Fahrenheit inside the column then causes the copper column to also cool to 55 degrees Fahrenheit and remain stable at 55 degrees Fahrenheit in all conditions due to the power of the pump and the size of the geothermal loop; and in warmer humid environmental conditions condensation will form on the outside of the column much like condensation forms on the outside of a glass of ice water; and where the water condensing on the outside of the column then descends the outside of the column via gravity; and in one embodiment that condensed water is captured by capture aprons spaced at intervals down the column; and those catch aprons port condensed water into a smaller gauge copper tubing wound progressively downward around the circumference of the geothermally-cooled column; and wherein that condensed water will also accelerate due to gravity and/or create water pressure at the end of the copper tubing wound around the larger copper column, and that copper tubing leads to a second Tesla turbine which will also generate electricity and where that electricity is used to partially meet the overall energy requirements of the system; and wherein water, the final output of the system, is then ported from that second Tesla turbine to a reservoir for later transfer to filtration, bottling, agriculture, or a plurality of other uses.

2. An iteration of claim 1 wherein the same basic structure is observed and an insulated pressure sleeve is created a short distance from the surface of the copper column and within that space adjacent to the column inside the pressure sleeve pressurized humid air is sent down from the top of the column via an air compressor; and as that humid air descends through that space adjacent to the copper column water vapor also condenses on the surface of the copper column but to a greater degree due to the higher volume of air; and in this iteration the column might also have the capture aprons and copper pipe coiled around the larger copper column as in claim 1, or not; but where at the bottom of that pressure sleeve condensed water and excess compressed air is sent through a pipe to a secondary Tesla turbine which uses the mix of accelerated water and air pressure to generate electricity which can be used to meet the overall energy requirements of the system; and leading from the secondary Tesla turbine, both water and compressed air are ported from that secondary Tesla turbine to a reservoir and inside the reservoir water falls to the bottom of the reservoir and air congregates at the top of the reservoir; and excess air pressure at the top of the reservoir can be ported to a third Tesla turbine to generate electricity which can be used to partially meet the overall energy requirements of the system; and where condensed water, the final output of the system is sent from the reservoir to filtration, bottling, agriculture, or a plurality of other uses.

3. An iteration of claim 1 where instead of a column of water descending a copper pipe, a series of micron-sized artificial xylem comprised by tubes or hexagons filling the pipe utilize capillary action to draw water upwards through the column, and narrowing of the artificial xylem at periodic intervals mimic perforation plates; and small holes left in the narrowing of the xylem at those artificial perforation plates have a small hole mimicking pits in natural perforation plates, and a pump at the base of the column mimicking root osmotic pressure pushes water upward through the artificial xylem, capillary action also draws water partially up the column due to Jurin's Law, and several possible evapotranspiration analogues at the top of the column draw water further up the interior of the column through the artificial Xylem in either a partially active manner through pumps at both the top and bottom of the system or in a partially passive manner similar to the method by which trees draw water up through their internal structure; and wherein those evapotranspiration analogues at the top of the column would include the creation of a partial vacuum through direct pumping action, the use of water responsive fabrics to mimic evapotranspiration, or the use of artificial leaves to mimic evapotranspiration; and where in the latter water would be drawn from top of the copper column by a small Tesla turbine or other pumping mechanism and ported to small metal branches supporting artificial leaves individually, or artificial leaves encased in larger panels collectively, and wherein those artificial leaves when surrounded by water and in the presence of sunlight trigger water electrolysis producing both hydrogen gas and oxygen gas and where that hydrogen gas and oxygen gas is then sent to capture tanks, or alternatively the hydrogen is sent to an electrical generator to partially offset the energy requirements of the system, or both the hydrogen gas and oxygen gas can be sent to a plurality of other uses; and the artificial xylem bringing water up the column in a partially passive manner will also cool the copper column creating condensation on the surface of the copper column, and wherein as in claim 1 the surface of the column could have catch aprons at intervals porting condensed water to a copper pipe wound around the surface of the copper column and where at the bottom of the copper column the water in the pipe would be ported to a Tesla turbine to generate electricity which can be used to partially meet the overall energy requirements of the system, and wherein condensed water, the final product of the system, is ported to a reservoir for bottling, reclamation, or a plurality of other uses including using that water as a source of water for the system itself, where a portion of that condensed water is ported back into the system, transported up the artificial xylem inside the column, reaches the artificial leaves at the top of the column to produce hydrogen and oxygen inside the artificial leaves at the top of the column.

4. An iteration of claim 1 wherein a metal light pole or telephone pole takes the place of the copper column and wherein water is ported directly to sewer systems or storm drains from the system.

5. An iteration of claim 2 in a spherical configuration wherein the surface area of a sphere is substituted for the surface area of a column but where all other components of claim 2 remain the same.

6. An iteration of claim 2 where the entire system is underground and instead of an insulated pressure sleeve protecting the column from ambient temperatures, the outer wall of the pressure sleeve is also made of copper and that copper is in direct contact with the ground or bedrock leading to additional surface area inside the pressure sleeve which is also geothermally cooled to 55 degrees Fahrenheit, and where catch aprons and copper pipes are also used to collect condensed water falling from both the inner wall of the pressure sleeve and the free-standing copper column in the center of the pressure sleeve, and where that falling condensed water along both the copper column and the inner wall of the pressure chamber is combined together with spare air pressure at the bottom of the pressure sleeve, and where that mix of high pressure air and water is then ported through a pipe to a Tesla turbine, and energy generated by the Tesla turbine is used to partially offset the overall energy requirements of the system.
